(19) United States
(12) Patent Application Publication
(10) Pub. No.: US 2021/0014133 A1
(43) Pub. Date: Jan. 14, 2021

(54) METHODS AND APPARATUS TO COORDINATE EDGE PLATFORMS

(71) Applicant: Intel Corporation, Santa Clara, CA (US)

(72) Inventors: Christian Maciocco, Portland, OR (US); Kshitij Doshi, Tempe, AZ (US); Francesc Guim Bernat, Barcelona (ES); Ned M. Smith, Beaverton, OR (US); Marcin Spoczynski, Leixlip (IE); Timothy Verrall, Pleasant Hill, CA (US); Rajesh Gadiyar, Chandler, AZ (US); Trevor Cooper, Portland, OR (US); Valerie Parker, Portland, OR (US)

(21) Appl. No.: 17/032,993

(22) Filed: Sep. 25, 2020

(51) Int. Cl. H04L 12/24; H04L 12/26; H04L 29/08

(52) U.S. Cl. CPC H04L 41/5009; H04L 41/5006; H04L 67/16; H04L 43/0805; H04L 43/0882

(57) ABSTRACT

Methods and apparatus to coordinate edge platforms are disclosed. A disclosed example apparatus includes to control processing of data associated with edges includes an orchestrator analyzer to determine a first performance requirement of a first microservice of an application and a second performance requirement of a second microservice of the application. The apparatus also includes an orchestrator controller to assign the first microservice and the second microservice across first and second edge nodes between a source network and a destination network by: assigning the first microservice to the first edge node based on a first capability of the first edge node satisfying the first performance requirement of the first microservice, and assigning the second microservice to the second edge node based on a second capability of the second edge node satisfying the second performance requirement of the second microservice.

### FIELD OF THE DISCLOSURE

This disclosure relates generally to computing in edge environments and, more particularly, to methods and apparatus to coordinate edge platforms.

### BACKGROUND

Edge environments (e.g., an Edge, Fog, multi-access edge computing (MEC), or Internet of Things (IoT) network) enable workload execution (e.g., execution of one or more computing tasks, execution of a machine learning model using input data, etc.), data storage, etc. near endpoint devices that request an execution of the workload, or components of the workload. Edge environments may include infrastructure, such as an edge platform with networking and storage capabilities, that is connected to cloud infrastructure, endpoint devices, and/or additional edge infrastructure via networks such as the Internet. Edge platforms, edge nodes or edges may be closer in proximity to endpoint devices than cloud infrastructure, such as centralized servers.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings are provided by way of example, and not limitation.

FIG. 1 illustrates an overview of an edge cloud configuration for edge computing.

FIG. 2 illustrates operational layers among endpoints, an edge cloud, and cloud computing environments.

FIG. 3 illustrates a block diagram of an example environment for networking and services in an edge computing system.

FIG. 4 illustrates deployment of a virtual edge configuration in an edge computing system operated among multiple edge nodes and multiple tenants.

FIG. 5 illustrates various compute arrangements deploying containers in an edge computing system.

FIG. 6 illustrates an example compute and communication use case involving mobile access to applications in an example edge computing system.

FIGS. 7A and 7B illustrate example edge topology in which examples disclosed herein can be implemented.

FIG. 8 is an example topology that illustrates example orchestration of edge clusters in accordance with teachings of this disclosure.

FIG. 9 is a block diagram of an example orchestrator coordinator to implement examples disclosed herein.

FIG. 10 is a flowchart representative of example machine readable instructions which may be executed to implement the edge computing systems illustrated in FIGS. 1-4, 6-8 and/or 9.

FIG. 11 is a flowchart representative of example machine readable instructions which may be executed to implement the edge computing systems illustrated in FIGS. 1-4, 6-8 and/or 9.

FIG. 12A is a block diagram of an example implementation of an example compute node that may be deployed in one of the edge computing systems illustrated in FIGS. 1-4, 6-8 and/or 9.

FIG. 12B is another block diagram of an example implementation of an example compute node that may be deployed in one of the edge computing systems illustrated in FIGS. 1-4, 6-8 and/or 9.

FIG. 13 is a block diagram of an example processing platform structured to execute the instructions of FIGS. 10 and 11 to implement the example the edge computing systems illustrated in FIGS. 1-4, 6-8 and/or 9.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein “substantially real time” refers to occurrence in a near instantaneous manner recognizing there may be real world delays for computing time, transmission, etc. Thus, unless otherwise specified, “substantially real time” refers to real time+/−1 second.

### DETAILED DESCRIPTION

Methods and apparatus to coordinate edge platforms are disclosed. Edge computing, at a general level, refers to the transition of compute and storage resources closer to endpoint devices (e.g., consumer computing devices, user equipment, etc.) in order to optimize total cost of ownership, operating expense, reduce application latency, reduce network backhaul traffic and energy, improve service capabilities, and improve compliance with data privacy or security requirements. Edge computing may, in some scenarios, provide a cloud-like distributed service that offers orchestration and management for applications among many types of storage and compute resources. As a result, some implementations of edge computing have been referred to as the “edge cloud” or the “fog,” as powerful computing resources previously available only in large remote data centers are moved closer to endpoints and made available for use by consumers at the “edge” of the network.

Edge computing use cases in mobile network settings have been developed for integration with multi-access edge computing (MEC) approaches, also known as “mobile edge computing.” MEC approaches are designed to allow application developers and content providers to access computing capabilities and an information technology (IT) service environment in dynamic mobile network settings at the edge of the network. Limited standards have been developed by the European Telecommunications Standards Institute (ETSI) industry specification group (ISG) in an attempt to define common interfaces for operation of MEC systems, platforms, hosts, services, and applications.

Edge computing, MEC, and related technologies attempt to provide reduced latency, increased responsiveness, reduce network backhaul traffic and energy, keep data local for improved privacy and security, and provide more available computing power and network bandwidth than offered in traditional cloud network services and wide area network connections. However, the integration of mobility and dynamically launched services to some mobile use and device processing use cases has led to limitations and concerns with orchestration, functional coordination, and resource management, especially in complex mobility settings where many participants (e.g., devices, hosts, tenants, service providers, operators, etc.) are involved.

In a similar manner, Internet of Things (IoT) networks and devices are designed to offer a distributed compute arrangement from a variety of endpoints. IoT devices can be physical or virtualized objects that may communicate on a network, and can include sensors, actuators, and other input/output components, which may be used to collect data or perform actions in a real-world environment. For example, IoT devices can include low-powered endpoint devices that are embedded or attached to everyday things, such as buildings, vehicles, packages, etc., to provide an additional level of artificial sensory perception of those things. In recent years, IoT devices have become more popular and thus applications using these devices have proliferated.

In some examples, an edge environment can include an enterprise edge in which communication with and/or communication within the enterprise edge can be facilitated via wireless and/or wired connectivity. The deployment of various Edge, Fog, MEC, and IoT networks, devices, and services have introduced a number of advanced use cases and scenarios occurring at and towards the edge of the network. However, these advanced use cases have also introduced a number of corresponding technical challenges relating to orchestration, security, processing and network resources, service availability and efficiency, among many other issues. One such challenge is in relation to Edge, Fog, MEC, and IoT networks, devices, and services executing workloads on behalf of endpoint devices.

The present techniques and configurations may be utilized in connection with many aspects of current networking systems, but are provided with reference to Edge Cloud, IoT, Multi-access Edge Computing (MEC), and other distributed computing deployments. The following systems and techniques may be implemented in, or augment, a variety of distributed, virtualized, or managed edge computing systems. These include environments in which network services are implemented or managed using multi-access edge computing (MEC), fourth generation (4G), fifth generation (5G) wireless or next generation network configurations; or in wired network configurations involving fiber, copper, and other connections. Further, aspects of processing by the respective computing components may involve computational elements which are in geographical proximity of a user equipment or other endpoint locations, such as a smartphone, vehicular communication component, IoT device, etc. Further, the presently disclosed techniques may relate to other Edge/MEC/IoT network communication standards and configurations, and other intermediate processing entities and architectures.

Edge computing is a developing paradigm where computing is performed at or closer to the “edge” of a network, typically through the use of a computing platform implemented at base stations, gateways, network routers, or other devices which are much closer to end point devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with computing hardware that performs virtualized network functions and offers compute resources for the execution of services and consumer functions for connected devices.

Edge environments include networks and/or portions of networks that are located between a cloud environment and an endpoint environment. Edge environments enable computations of workloads at edges of a network. For example, an endpoint device may request a nearby base station to compute a workload rather than a central server in a cloud environment. Edge environments include edge platforms or edges, which include pools or clusters of memory, storage resources, and/or processing resources. These edges perform computations, such as an execution of a workload, on behalf of other edges and/or edge nodes. Edge environments facilitate connections between producers (e.g., workload executors, edges) and consumers (e.g., other edges, endpoint devices).

Because edges may be closer in proximity to endpoint devices than centralized servers in cloud environments, edges enable computations of workloads with a lower latency (e.g., response time) than cloud environments. Edges may also enable a localized execution of a workload based on geographic locations or network topographies. For example, an endpoint device may require a workload to be executed in a first geographic area, but a centralized server may be located in a second geographic area. The endpoint device can request a workload execution by an edge node located in the first geographic area to comply with corporate or regulatory restrictions. Other policies could drive the execution in the edge node (e.g., energy/power saving, network backhaul traffic reduction).

Examples of workloads to be executed in an edge environment include autonomous driving computations, video surveillance monitoring, machine learning model executions, and real time data analytics. Additional examples of workloads include delivering and/or encoding media streams, measuring advertisement impression rates, object detection in media streams, speech analytics, asset and/or inventory management, and augmented reality processing.

Edge nodes or edges enable both the execution of workloads and a return of a result of an executed workload to endpoint devices with a response time lower than the response time of a server in a cloud environment. For example, if an edge is located closer to an endpoint device on a network than a cloud server, the edge service may respond to workload execution requests from the endpoint device faster than the cloud server. An endpoint device may request an execution of a time-constrained workload from an edge service rather than a cloud server.

In addition, edge nodes enable the distribution and decentralization of workload executions. For example, an endpoint device may request a first workload execution and a second workload execution. In some examples, a cloud server may respond to both workload execution requests. With an edge environment, however, a first edge may execute the first workload execution request, and a second edge may execute the second workload execution request.

To meet the low-latency and high-bandwidth demands of endpoint devices, orchestration in edge clouds is performed on the basis of timely information about the utilization of many resources (e.g., hardware resources, software resources, virtual hardware and/or software resources, etc.), and the efficiency with which those resources are able to meet the demands placed on them. Such timely information is generally referred to as telemetry data or telemetry information.

Some edge networks are governed based on a Service Level Agreement (SLA). The SLA can include Quality of Service (QoS), bandwidth and/or latency requirements. For example, edges arranged between a source network (e.g., a main server, a central office, etc.) and a destination network (e.g., a data center, a wireless access network, etc.) that is remote from the source network can have difficulties meeting the SLA when one or more of these edge nodes experiences a bottleneck, failure and/or reduced performance. In particular, for edge nodes arranged in a chain-like structure between the source network and the destination network, even a single edge node with reduced performance or capacity can prevent the overall network from performing at levels defined by the SLA.

Examples disclosed herein enable edge nodes in a chain (e.g., a hierarchical chain) to coordinate and re-assign resources so that requirements of an SLA (e.g., an end-to-end SLA) can be complied with. For example, by assigning workloads (e.g., microservices) to ones of the edge nodes based on edge capabilities, as well as application performance requirements (e.g., specified in application telemetry data), examples disclosed herein are highly adaptable to adverse processing, resource and/or network conditions. In other words, examples disclosed herein allocate the workloads to resources that have commensurate capabilities and, thus, are effective at distributed computing amongst different edge nodes. Accordingly, examples disclosed herein can also enable efficient execution of microservices associated with applications on multiple interconnected edges to comply with requirements set forth in the SLA. Examples disclosed herein monitor and/or analyze telemetry information and, accordingly, assign workloads to orchestrators of edge nodes that are topologically arranged in a chain. In other words, coordinated execution of the workloads is enabled based on the SLA, thereby enabling better utilization and more efficient use of edge network, compute, cache and/or storage capabilities amongst the interconnected edge nodes. Examples disclosed herein can be implemented on edge nodes that are arranged vertically, hierarchically and/or in a chain-like structure to one another. In particular, the aforementioned edge nodes can be arranged sequentially (e.g., daisy-chained) between a source network, such as a main server for example, and a destination (e.g., a user access network, a network endpoint, a data center, etc.).

Examples disclosed herein may be implemented on one or more orchestrators of different edge nodes, for example. Alternatively, examples disclosed herein can be implemented on hardware communicatively coupled to the orchestrators. Some examples disclosed herein include a communication interface to communicatively couple orchestrators of edge nodes of a chain of edge nodes. However, any appropriate number of orchestrators and/or edge nodes can be implemented instead. In examples disclosed herein, an orchestrator analyzer determines a first performance requirement of a first microservice of an application, as well as a second performance requirement of a second microservice of the application. In some examples, the orchestrator analyzer determines an availability of the first and second edge nodes based on communication between the first and second orchestrators, for example. The orchestrator analyzer may also query at least one of the orchestrators to determine the availability. The communication can include telemetry information of the corresponding edges (e.g., performance capabilities of each of the edges, availability or resources, etc.), for example. In turn, an orchestrator controller schedules the first microservice and/or workload to a first edge node of the edges and the second microservice to a second edge node of the edges based on the determination of availability and the capabilities of the first and second edge nodes (e.g., processor capabilities, cache capabilities, memory capabilities, etc.) in combination with the first and second performance requirements of the first and second microservices, respectively, thereby enabling the requirements of the SLA to be met. Additionally or alternatively, the first and second microservices are assigned based on the aforementioned SLA. As a result, conditions and/or requirements of the SLA can be fulfilled in a time-efficient and resource-efficient manner.

The communication interface, the orchestrator analyzer and/or the orchestrator controller can be implemented on a single edge node, edge cluster or an orchestrator. Alternatively, the communication interface, the orchestrator analyzer and/or the orchestrator controller can be implemented on multiple edges, edge clusters or orchestrators. In some examples, an application manager is implemented to query at least one of an application and/or microservices associated with the application to determine application telemetry data thereof which, in turn, can be used for workload assignments to different computes. The application telemetry data can correspond to resource requirements of the application (e.g., cache requirements, data storage requirements, processor requirements, etc.). Additionally or alternatively, an incentive controller is implemented to forward and/or provide an incentive (e.g., a financial inventive, a duty time shift incentive, etc.) to the first or second edge node. In some examples, an execution monitor is implemented to monitor execution of microservices. This monitoring can be used to analyze telemetry data of the edge nodes and/or analyze application/pod container resource utilization (e.g., memory usage, cache usage, storage, etc.)

As used herein, referring to edges/edge networks and/or edge clusters as being or along “a chain” means that an edge/edge network and/or edge cluster is communicatively coupled to at least one other edge/edge network and/or edge cluster and arranged between a source network and a destination network. Accordingly, “a chain” can refer to edge networks, edge nodes and/or edge clusters networked or chained between (e.g., daisy chained, forming a chain in between) the source network and the destination network. As used herein, the terms “edge” and “edge node” refer to an edge node or edge platform that includes at least one edge cluster to run microservices associated with at least one application. As used herein, the term “workload” refers to a unit or package of computation and/or scheduled computation and/or execution that can be deployed for later execution or processing, such as a container pod or a microservice, for example. As used herein, the term “capability” for an edge node or edge platform refers to a performance capability associated with the edge node including, but not limited to processor capability, memory capability, I/O capability, cache capability and/or storage capability.

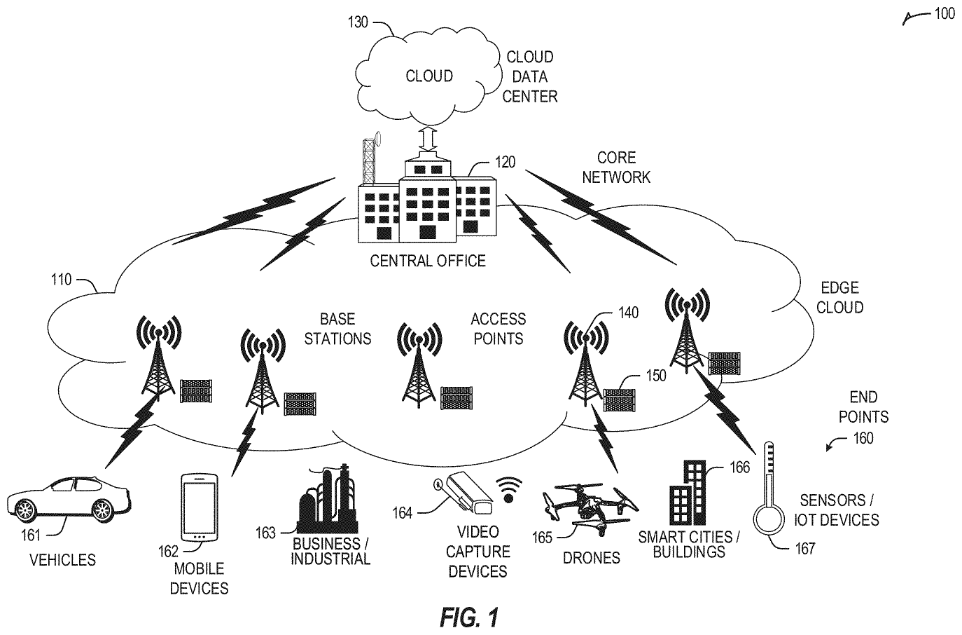

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge,” “close edge,” “local edge,” “middle edge,” or “far edge” layers, depending on latency, distance, and timing characteristics.

Edge computing is a developing paradigm where computing is performed at or closer to the “edge” of a network, typically through the use of a compute platform (e.g., a generic compute platform, x86 or ARM compute hardware architecture) with accelerators (e.g. FPGA, GPU) implemented at base stations, gateways, network routers, or other devices which are much closer to endpoint devices producing and consuming the data (e.g., at a “local edge”, “close edge”, or “near edge”). For example, edge gateway servers may be equipped with pools of memory and storage resources to perform computation in real-time for low latency use-cases (e.g., autonomous driving, industrial IOT or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

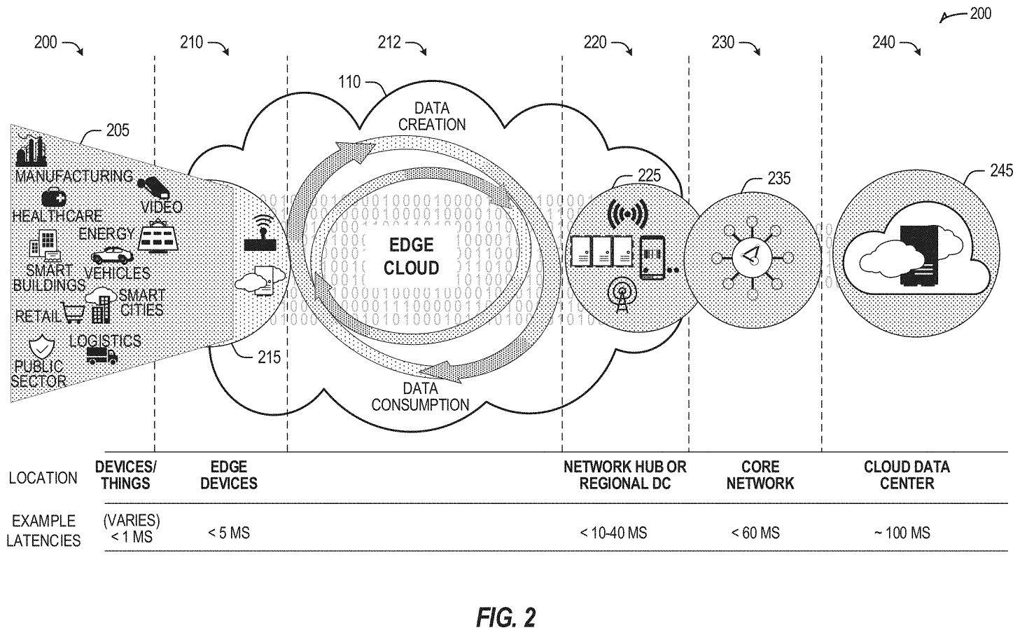

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and QoS (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because edge locations may be unmanned and may even need permissioned access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes. Accordingly, by being highly adaptable to adverse resource constraints and/or network fluctuations, examples disclosed herein can mitigate these issues by effectively assigning workloads between different edges.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

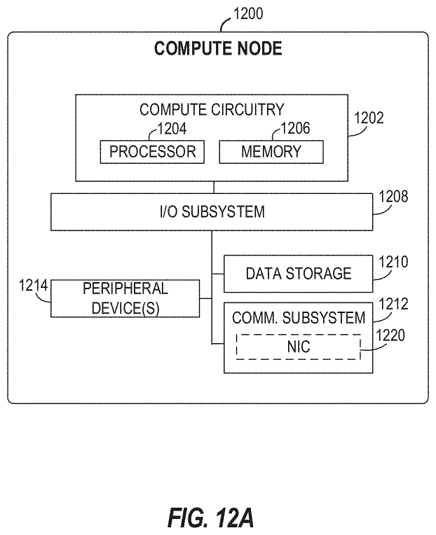

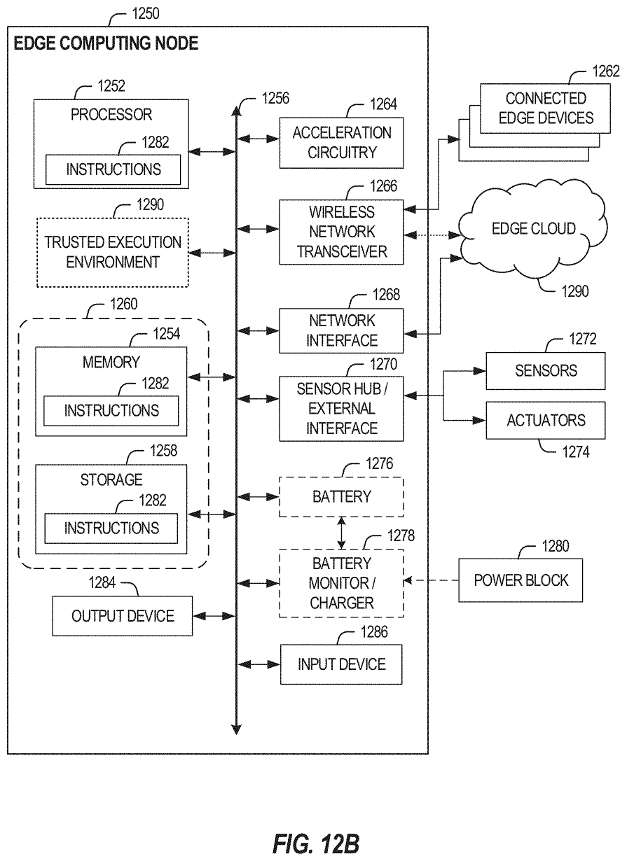

The network components of the edge cloud 110 may be servers, multi-tenant servers, appliance computing devices, and/or any other type of computing devices. For example, the edge cloud 110 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 12B. The edge cloud 110 may also include one or more servers and/or one or more multi-tenant servers. Such a server may include an operating system and a virtual computing environment. A virtual computing environment may include a hypervisor managing (spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

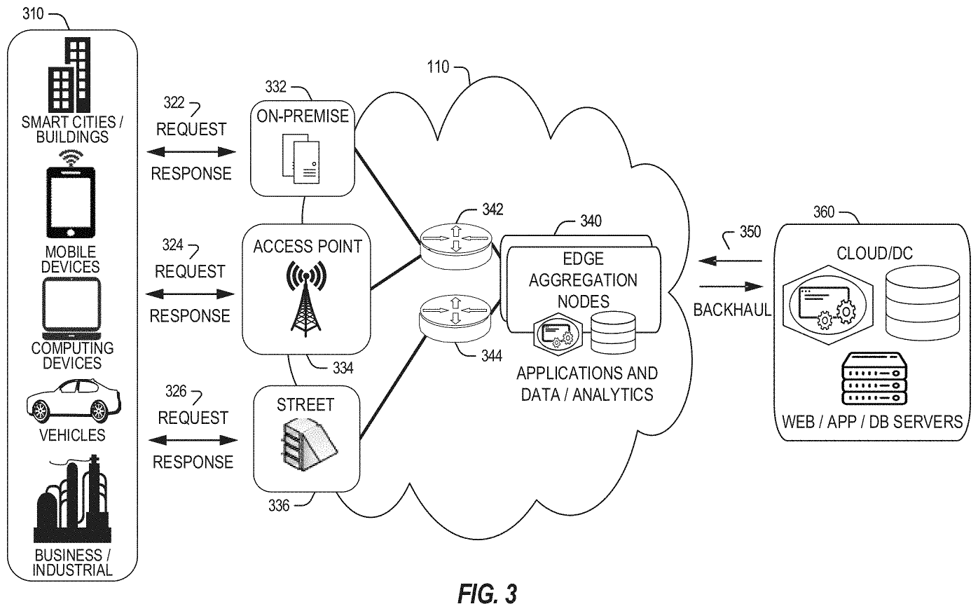

FIG. 3 illustrates a block diagram of an example environment 300 in which various client endpoints 310 (in the form of mobile devices, computers, autonomous vehicles, business computing equipment, industrial processing equipment) exchange requests and responses with the example edge cloud 110. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

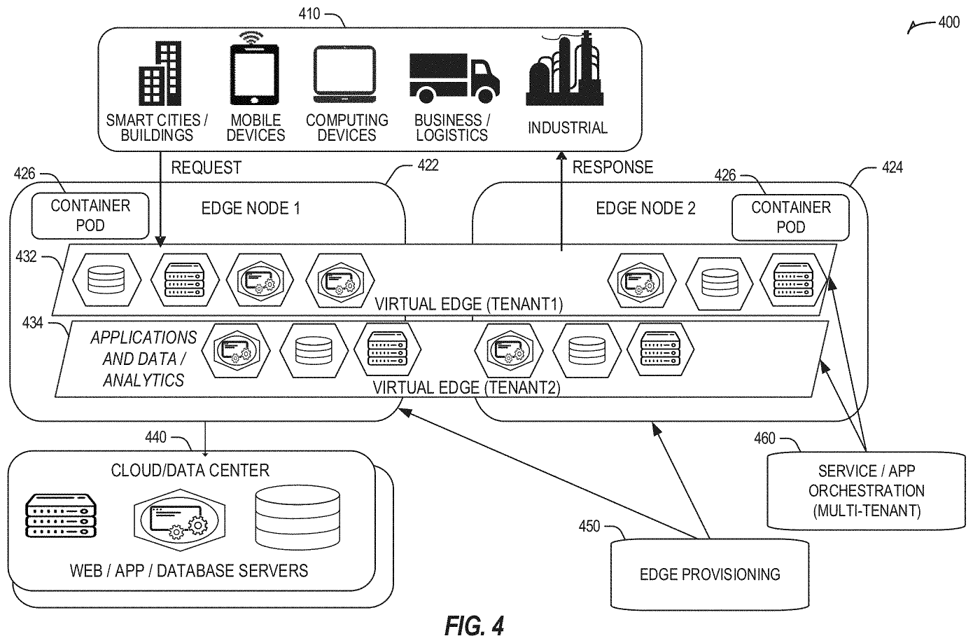

FIG. 4 illustrates deployment and orchestration for virtual edge configurations across an edge computing system operated among multiple edge nodes and multiple tenants. Specifically, FIG. 4 depicts coordination of a first edge node 422 and a second edge node 424 in an edge computing system 400, to fulfill requests and responses for various client endpoints 410 (e.g., smart cities/building systems, mobile devices, computing devices, business/logistics systems, industrial systems, etc.), which access various virtual edge instances. Here, the virtual edge instances 432, 434 provide edge compute capabilities and processing in an edge cloud, with access to a cloud/data center 440 for higher-latency requests for websites, applications, database servers, etc. However, the edge cloud enables coordination of processing among multiple edge nodes for multiple tenants or entities.

In the example of FIG. 4, these virtual edge instances include: a first virtual edge 432, offered to a first tenant (Tenant 1), which offers a first combination of edge storage, computing, and services; and a second virtual edge 434, offering a second combination of edge storage, computing, and services. The virtual edge instances 432, 434 are distributed among the edge nodes 422, 424, and may include scenarios in which a request and response are fulfilled from the same or different edge nodes. The configuration of the edge nodes 422, 424 to operate in a distributed yet coordinated fashion occurs based on edge provisioning functions 450. The functionality of the edge nodes 422, 424 to provide coordinated operation for applications and services, among multiple tenants, occurs based on orchestration functions 460.

It should be understood that some of the devices 410 are multi-tenant devices where Tenant 1 may function within a tenant1 ‘slice’ while a Tenant 2 may function within a tenant2 ‘slice’ (and, in further examples, additional or sub-tenants may exist; and each tenant may even be specifically entitled and transactionally tied to a specific set of features all the way day to specific hardware features). A trusted multi-tenant device may further contain a tenant-specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 422, 424 may operate as security feature enforcement points for local resources allocated to multiple tenants per node. Additionally, tenant runtime and application execution (e.g., in instances 432, 434) may serve as an enforcement point for a security feature that creates a virtual edge abstraction of resources spanning potentially multiple physical hosting platforms. Finally, the orchestration functions 460 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitioning may contain a RoT capability and where fan-out and layering according to a DICE model may further be applied to Edge Nodes. Cloud computing nodes consisting of containers, FaaS engines, Servlets, servers, or other computation abstraction may be partitioned according to a DICE layering and fan-out structure to support a RoT context for each. Accordingly, the respective devices 410, 422, and 440 spanning RoTs may coordinate the establishment of a distributed trusted computing base (DTCB) such that a tenant-specific virtual trusted secure channel linking all elements end to end can be established.

Further, it will be understood that a container may have data or workload specific keys protecting its content from a previous edge node. As part of migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 4. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or, respective computing systems and resources which are co-owned or co-managed by multiple owners).

For instance, each of the edge nodes 422, 424 may implement the use of containers, such as with the use of a container “pod” 426, 428 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices 432, 434 are partitioned according to the needs of each container.

With the use of container pods, a pod controller oversees the partitioning and allocation of containers and resources. The pod controller receives instructions from an orchestrator (e.g., the orchestrator 460) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 460 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute and a different shared pod controller is installed and invoked prior to the second pod executing.

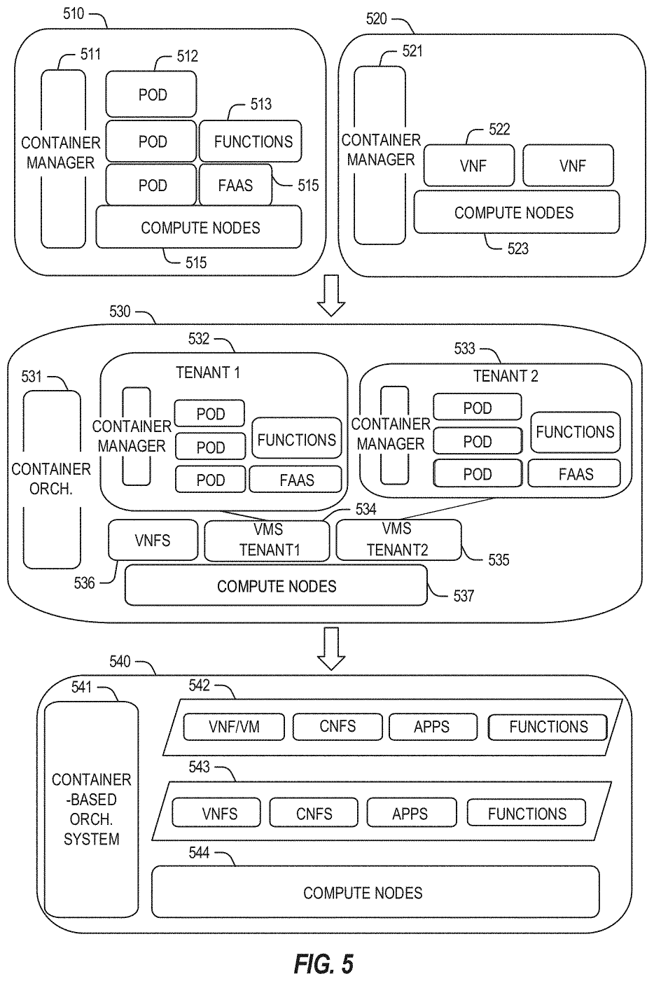

FIG. 5 illustrates additional compute arrangements deploying containers in an edge computing system. The example pod deployment examples of FIG. 5 can be implemented in conjunction with workload deployment of examples disclosed herein in which pods are transferred between different edges along a chain (e.g., a hierarchical chain), for example, so that the pods can executed by available compute resources. As a simplified example, system arrangements 510, 520 depict settings in which a pod controller (e.g., container managers 511, 521, and a container orchestrator 531) is adapted to launch containerized pods, functions, and functions-as-a-service instances through execution via compute nodes (515 in arrangement 510), or to separately execute containerized virtualized network functions through execution via compute nodes (523 in arrangement 520). This arrangement is adapted for use of multiple tenants in an example system arrangement 530 (using compute nodes 537), where containerized pods (e.g., pods 512), functions (e.g., functions 513, VNFs 522, 536), and functions-as-a-service instances (e.g., FaaS instance 515) are launched within virtual machines (e.g., VMs 534, 535 for tenants 532, 533) specific to respective tenants (aside the execution of virtualized network functions). This arrangement is further adapted for use in system arrangement 540, which provides containers 542, 543, or execution of the various functions, applications, and functions on compute nodes 544, as coordinated by an container-based orchestration system 541.

The system arrangements of depicted in FIG. 5 provides an architecture that treats VMs, Containers, and Functions equally in terms of application composition (and resulting applications are combinations of these three ingredients). Each ingredient may involve use of one or more accelerator (FPGA, ASIC) components as a local backend. In this manner, applications can be split across multiple edge owners, coordinated by an orchestrator.

In the context of FIG. 5, the pod controller/container manager, container orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves and hardware partitioning schemes may be used by edge owners to enforce tenancy. Other isolation environments may include: bare metal (dedicated) equipment, virtual machines, containers, virtual machines on containers, or combinations thereof.

In further examples, aspects of software-defined or controlled silicon hardware, and other configurable hardware, may integrate with the applications, functions, and services an edge computing system. Software defined silicon may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

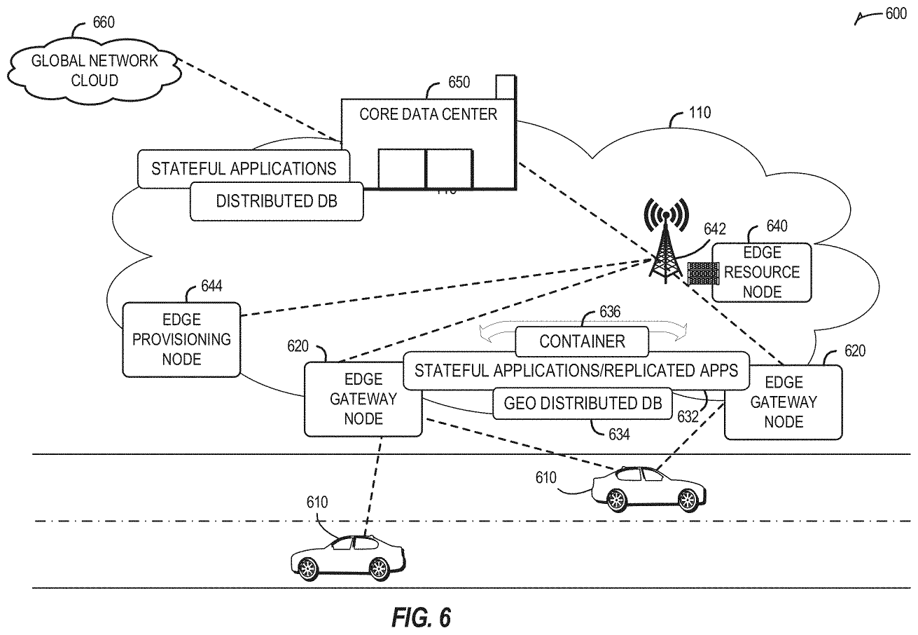

It should be appreciated that the edge computing systems and arrangements discussed herein may be applicable in various solutions, services, and/or use cases involving mobility. As an example, FIG. 6 shows an example simplified vehicle compute and communication use case involving mobile access to applications in an example edge computing system 600 that implements an edge cloud such as the edge cloud 110 of FIG. 1. In this use case, respective client compute nodes 610 may be embodied as in-vehicle compute systems (e.g., in-vehicle navigation and/or infotainment systems) located in corresponding vehicles which communicate with example edge gateway nodes 620 during traversal of a roadway. For instance, the edge gateway nodes 620 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 610 and a particular one of the edge gateway nodes 620 may propagate so as to maintain a consistent connection and context for the example client compute node 610. Likewise, mobile edge nodes may aggregate at the high priority services or according to the throughput or latency resolution requirements for the underlying service(s) (e.g., in the case of drones). The respective edge gateway devices 620 include an amount of processing and storage capabilities and, as such, some processing and/or storage of data for the client compute nodes 610 may be performed on one or more of the edge gateway nodes 620.

The edge gateway nodes 620 may communicate with one or more edge resource nodes 640, which are illustratively embodied as compute servers, appliances or components located at or in a communication base station 642 (e.g., a based station of a cellular network). As discussed above, the respective edge resource node(s) 640 include an amount of processing and storage capabilities and, as such, some processing and/or storage of data for the client compute nodes 610 may be performed on the edge resource node(s) 640. For example, the processing of data that is less urgent or important may be performed by the edge resource node(s) 640, while the processing of data that is of a higher urgency or importance may be performed by the edge gateway devices 620 (depending on, for example, the capabilities of each component, or information in the request indicating urgency or importance). Based on data access, data location or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 640 also communicate with the core data center 650, which may include compute servers, appliances, and/or other components located in a central location (e.g., a central office of a cellular communication network). The example core data center 650 may provide a gateway to the global network cloud 660 (e.g., the Internet) for the edge cloud 110 operations formed by the edge resource node(s) 640 and the edge gateway devices 620. Additionally, in some examples, the core data center 650 may include an amount of processing and storage capabilities and, as such, some processing and/or storage of data for the client compute devices may be performed on the core data center 650 (e.g., processing of low urgency or importance, or high complexity).

The edge gateway nodes 620 or the edge resource node(s) 640 may offer the use of stateful applications 632 and a geographic distributed database 634. Although the applications 632 and database 634 are illustrated as being horizontally distributed at a layer of the edge cloud 110, it will be understood that resources, services, or other components of the application may be vertically distributed throughout the edge cloud (including, part of the application executed at the client compute node 610, other parts at the edge gateway nodes 620 or the edge resource node(s) 640, etc.). Additionally, as stated previously, there can be peer relationships at any level to meet service objectives and obligations. Example disclosed herein can enable effective control of resources to meet service objectives and obligations based on an SLA, for example. Further, the data for a specific client or application can move from edge to edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a container 636 (or pod of containers) may be flexibly migrated from one of the edge nodes 620 to other edge nodes (e.g., another one of edge nodes 620, one of the edge resource node(s) 640, etc.) such that the container with an application and workload does not need to be reconstituted, re-compiled, re-interpreted in order for migration to work. However, in such settings, there may be some remedial or “swizzling” translation operations applied. For example, the physical hardware at the edge resource node(s) 640 may differ from the hardware at the edge gateway nodes 620 and therefore, the hardware abstraction layer (HAL) that makes up the bottom edge of the container will be re-mapped to the physical layer of the target edge node. This may involve some form of late-binding technique, such as binary translation of the HAL from the container native format to the physical hardware format, or may involve mapping interfaces and operations. A pod controller may be used to drive the interface mapping as part of the container lifecycle, which includes migration to/from different hardware environments.

The scenarios encompassed by FIG. 6 may utilize various types of mobile edge nodes, such as an edge node hosted in a vehicle (car/truck/tram/train) or other mobile unit, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 620, some others at the edge resource node(s) 640, and others in the core data center 650 or global network cloud 660.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code (e.g., an application which may be provided by a third party) is executed. The container may be any isolated-execution entity such as a process, a Docker or Kubernetes (K8s) container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, container is “spun down” (e.g., deactivated and/or deallocated) on the infrastructure in response to the execution being completed.

Further aspects of FaaS may enable deployment of edge functions in a service fashion, including a support of respective functions that support edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require initialization, deployment, or configuration).

The edge computing system 600 can include or be in communication with an edge provisioning node 644. The edge provisioning node 644 can distribute software such as the example computer readable instructions 1282 of FIG. 12B, to various receiving parties for implementing any of the methods described herein. The example edge provisioning node 644 may be implemented by any computer server, home server, content delivery network, virtual server, software distribution system, central facility, storage device, storage node, data facility, cloud service, etc., capable of storing and/or transmitting software instructions (e.g., code, scripts, executable binaries, containers, packages, compressed files, and/or derivatives thereof) to other computing devices. Component(s) of the example edge provisioning node 644 may be located in a cloud, in a local area network, in an edge network, in a wide area network, on the Internet, and/or any other location communicatively coupled with the receiving party(ies). The receiving parties may be customers, clients, associates, users, etc. of the entity owning and/or operating the edge provisioning node 644. For example, the entity that owns and/or operates the edge provisioning node 644 may be a developer, a seller, and/or a licensor (or a customer and/or consumer thereof) of software instructions such as the example computer readable instructions 1282 of FIG. 12B. The receiving parties may be consumers, service providers, users, retailers, OEMs, etc., who purchase and/or license the software instructions for use and/or re-sale and/or sub-licensing.

In an example, edge provisioning node 644 includes one or more servers and one or more storage devices. The storage devices host computer readable instructions such as the example computer readable instructions 1282 of FIG. 12B, as described below. Similarly to edge gateway devices 620 described above, the one or more servers of the edge provisioning node 644 are in communication with a base station 642 or other network communication entity. In some examples, the one or more servers are responsive to requests to transmit the software instructions to a requesting party as part of a commercial transaction. Payment for the delivery, sale, and/or license of the software instructions may be handled by the one or more servers of the software distribution platform and/or via a third party payment entity. The servers enable purchasers and/or licensors to download the computer readable instructions 1282 from the edge provisioning node 644. For example, the software instructions, which may correspond to the example computer readable instructions 1282 of FIG. 12B, may be downloaded to the example processor platform/s, which is to execute the computer readable instructions 1282 to implement the methods described herein.

In some examples, the processor platform(s) that execute the computer readable instructions 1282 can be physically located in different geographic locations, legal jurisdictions, etc. In some examples, one or more servers of the edge provisioning node 644 periodically offer, transmit, and/or force updates to the software instructions (e.g., the example computer readable instructions 1282 of FIG. 12B) to ensure improvements, patches, updates, etc. are distributed and applied to the software instructions implemented at the end user devices. In some examples, different components of the computer readable instructions 1282 can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

In further examples, any of the compute nodes or devices discussed with reference to the present edge computing systems and environment may be fulfilled based on the components depicted below in connection with FIGS. 12A and 12B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

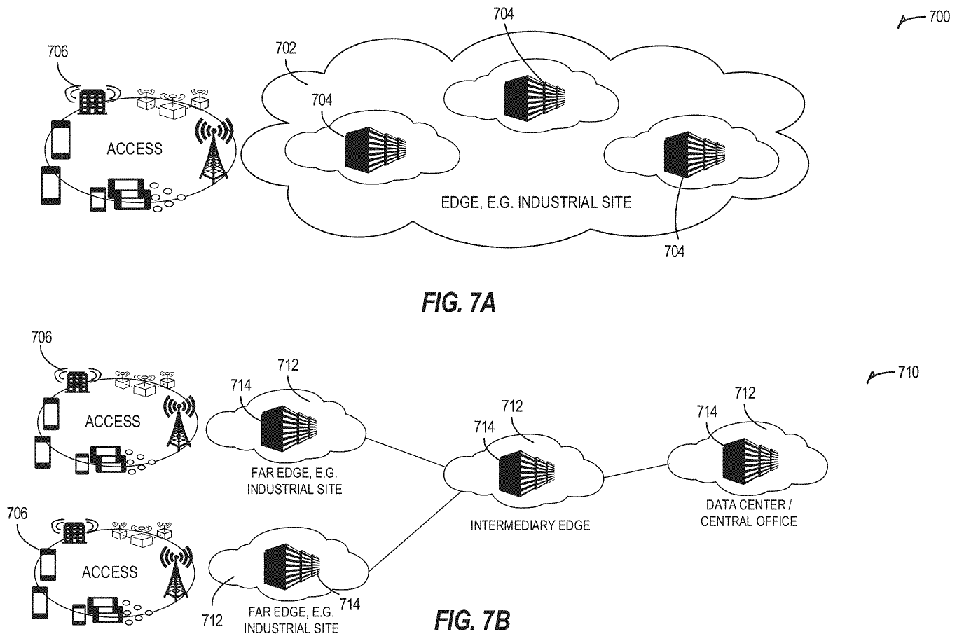

FIGS. 7A and 7B illustrate example edge topology in which examples disclosed herein can be implemented. In particular, the example edge configurations and topology discussed above in connection with FIGS. 1-6 can be implemented with any of the examples described below in connection with FIGS. 7A-12. Turning to FIG. 7A, an example edge topology 700 is shown with an edge (e.g., an edge platform, a network edge, etc.) 702 having multiple edge clusters 704. In turn, the aforementioned edge 702 is communicatively coupled to an access network 706. The edge 702 can be part of a far edge industrial site, for example.

In operation, the edge clusters 704 include compute, storage and network resources. The compute, storage and network resources of the edge clusters 704 are independently orchestrated based on use of the access network 706. According to examples disclosed herein, cross-cluster orchestration is enabled, thereby enabling compute, storage and network resources to be more effectively utilized. Further, examples disclosed herein enable cross-cluster orchestration based on an SLA, which can be defined by an administrator, operator and/or developer. For example, QoS standards can be maintained across an entire system or the overall edge 702.

FIG. 7B illustrates an example edge topology 710, which is similar to the example of FIG. 7A but, instead, depicts multiple edge nodes (e.g., edges, edge platforms, etc.) 712 with corresponding edge clusters 714. In the illustrated example of FIG. 7B the edge nodes 712 are topologically arranged in a chain and/or sequential order (e.g., a daisy-chain structure, along a communication line, etc.) relative to one another. In particular, the example edge nodes 712 span between a source network (e.g., the core network 235 of FIG. 2) and an access network (e.g., the access network 706, devices/things of the use cases 205 of FIG. 2, etc.). In this example, the edge nodes 712 depicted closest to the access networks 706 are at a far edge industrial site while the edge nodes 712 depicted farthest from the access networks 706 are closest to a data center or central office. Examples disclosed herein can be effective on coordinating resource usage while maintaining service requirements defined by an SLA across the aforementioned chain. In some examples, a hierarchy of one of the edge nodes 712 is defined by its position within the chain (e.g., the edge node 712 closest to the data center/central office is a primary edge). In some such examples, ones of the edge nodes 712 manage and/or control the other edge nodes 712.

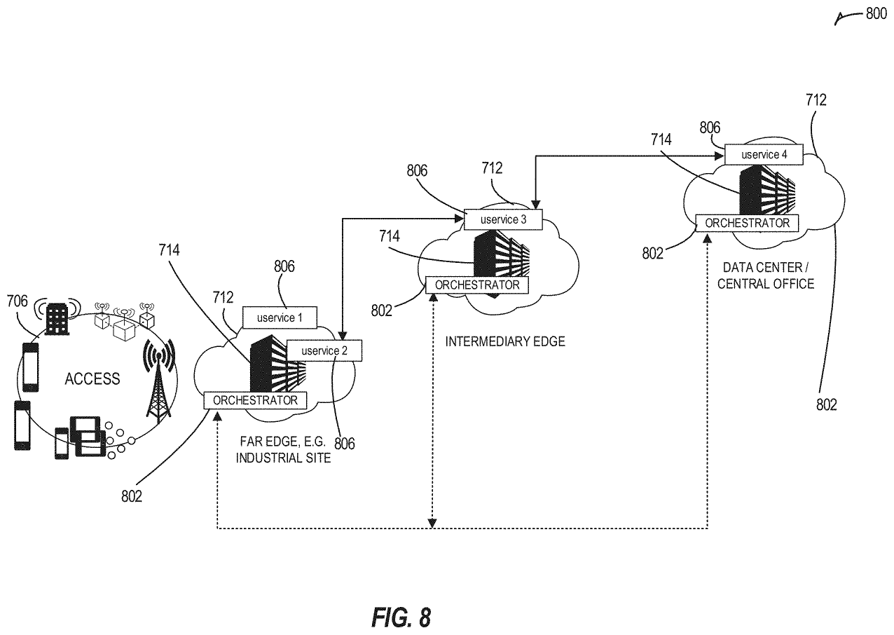

FIG. 8 is an example topology 800 that illustrates example coordination and/or orchestration of edges and/or edge clusters in accordance with teachings of this disclosure. In the illustrated example of FIG. 8, the coordination is shown in the context of the example chained (e.g., daisy-chained) edge nodes 712 shown in FIG. 7B. However, the example orchestration can be implemented in any appropriate edge and/or edge cluster topology, including any of the implementations disclosed herein. In this example, the edge nodes 712 include the corresponding edge clusters 714 and are arranged sequentially between the access network and a main data source (e.g., a data trunk, a main server node, a central server, a regional server, etc.), which is not shown. In the illustrated example, each of the edge clusters 714 includes a respective orchestrator 802, which is implemented as a K8s orchestrator to schedule and/or coordinate a K8s pod.

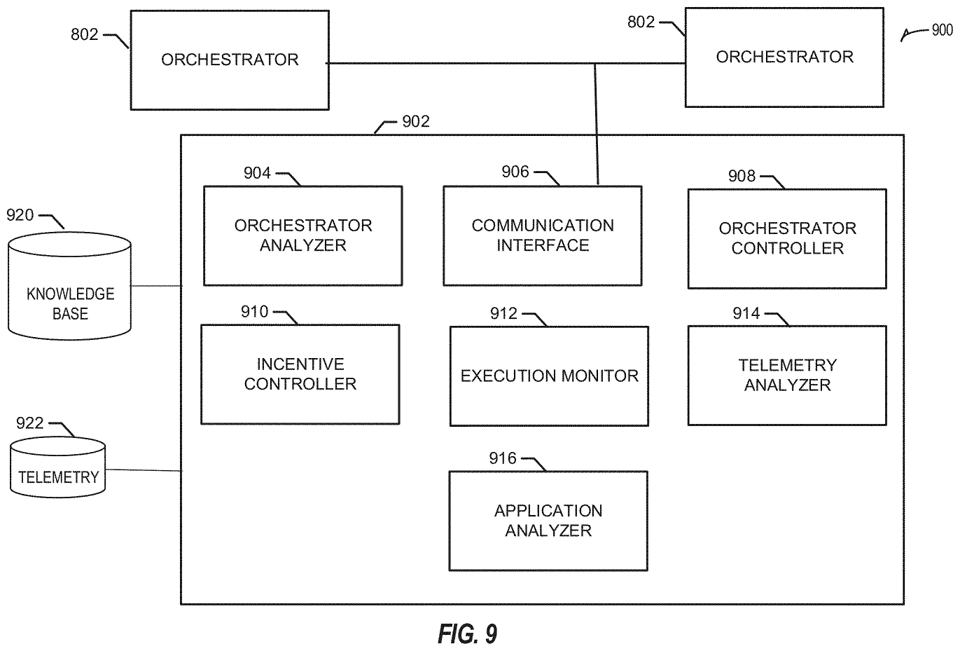

In operation, to maintain services (e.g., compute services, storage services, memory services, cache services, etc.) within requirements of the SLA, the orchestrators 802, which are arranged along a chain, are coordinated and/or controlled based on availability corresponding to telemetry data, application data (e.g., application finger printing data, application fingerprints) and the requirements (e.g., performance requirements, availability requirements, etc.) defined in the SLA. For example, the orchestration/coordination of the illustrated example can be performed to maintain a QoS defined by the SLA. In particular, the QoS may be based on latency requirements, bandwidth levels, etc. Accordingly, as will be described in greater detail below in connection with FIGS. 9-12, the orchestrators 802 are communicatively coupled to one another to determine availability (e.g., service availability, compute availability, etc.) of the edge clusters 714 and/or the edge nodes 712. In turn, based on the availability and the aforementioned SLA, the orchestrators 802 assign a workload, which may be a pod (e.g., a pod that includes multiple microservices associated with an application), to at least one of the hierarchically arranged edge nodes 712 and/or the associated clusters 714 of the edge nodes 712. In the illustrated example, microservices 806, which are designated as “uservice 1,” “uservice 2,” “uservice 3,” “uservice 4,” respectively, in the example of FIG. 8, are assigned to multiple ones of the edge nodes 712 based on the SLA and the availability of the edge nodes 712 and/or the respective edge clusters 714. As a result, services provided by the edge nodes 712 are distributed to more effectively meet requirements set forth by the SLA. To further maintain performance at levels at or exceeding the SLA, telemetry information or data is communicated between the edge nodes 712 via the orchestrators 802. In other examples, workloads can involve FaaS or any other EaaS implementation.

In some examples, one of the orchestrators 802 acts as a primary orchestrator while others of the orchestrators 802 act as secondary orchestrators that are controlled and/or directed by the primary orchestrator. In other words, in such examples, the primary orchestrator 802 can act as a controlling, managing, coordinating or directing orchestrator. In other examples, the orchestrators 802 perform distributed decision making to determine which of the edge nodes 712 is to be allocated, assigned and/or scheduled the workload. In some examples, services and/or microservices are moved or transferred away from a compute of one of the edge nodes 712 to comply with the SLA.

Examples disclosed herein can be implemented in hardware including a single structure of multiple structures (e.g., server hardware, computing hardware, etc.). For example, the edge nodes 712, the edge cluster 714 and/or the orchestrators 802 can be implemented in computer and/or networking hardware, which can include a housing, louvers, cooling boards, busses, printed circuit boards, power supplies, frames, etc.

FIG. 9 is a block diagram of an example orchestrator coordinator 900 to implement examples disclosed herein. For example, the orchestrator coordinator 900 can be implemented on any of the edges 702, 712 and/or the edge clusters 704, 714 and/or of FIGS. 7A-8, or any other suitable example disclosed herein and shown in connection FIGS. 1-6. For example, the orchestrator coordinator 900 could be implemented in any of the core network and/or the edge cloud 110 of the example edge computing configurations shown in FIGS. 1-8 or combinations thereof. In some examples, the orchestrator coordinator 900 is implemented in the first edge node 422, the second edge node 424 and/or the edge computing system 400 shown in FIG. 4. Additionally or alternatively, orchestrator coordinator 900 can be implemented in conjunction with the example container deployment (e.g., pod container deployment) shown in FIG. 5. Even further, examples disclosed may be implemented with at least one of the edge gateway nodes 620, the edge resource nodes 640 or the edge provisioning nodes 644 described and shown in connection with the example edge computing system 600 of FIG. 6.

The orchestrator coordinator 900 of the illustrated example can be implemented on a single orchestrator (e.g., the orchestrator 802, a primary orchestrator, a commanding orchestrator, a coordinating orchestrator, etc.), multiple orchestrators (e.g., distributed over multiple ones of the orchestrators 802), or to a computing device external to an edge cluster. In some examples, the orchestrator coordinator is implemented on one orchestrator that is in communication with other orchestrators of different edge clusters. The example orchestrator coordinator 900 includes an orchestrator manager 902 which, in turn, includes an orchestrator analyzer 904, a communication interface 906, an orchestration controller 908, an incentive controller 910, an execution monitor 912, a telemetry analyzer 914 and an application analyzer 916. In the illustrated example of FIG. 9, the orchestrator manager 902 is communicatively coupled to a knowledge base 920 and telemetry data storage 922, which can include telemetry data (e.g., counters, processor usage information, storage information, cache utilization, etc.) associated with the edge nodes 712 and/or the edge clusters 714.

The orchestrator analyzer 904 of the illustrated example determines conditions (e.g., telemetry data, application telemetry data, availability, etc.) of the corresponding orchestrators 802. In this example, the orchestrator analyzer 904 determines an availability of the orchestrators 802. In particular, the orchestrator analyzer 904 determines whether the corresponding edge nodes 712 of the orchestrators 802 are available to perform compute tasks while meeting requirements of an SLA. In some examples, the orchestrator analyzer 904 is continuously and/or periodically provided with availability data/information from the orchestrators 802. Additionally or alternatively, the orchestrator analyzer 904 queries the orchestrators 802 and/or their associated edge nodes 712 to determine an availability thereof. In some examples, the orchestrator analyzer 904 determines which of the edge nodes 712 and/or the edge clusters 714 are available. In this example, the orchestrator analyzer 904 determines and/or maintains data related to capabilities (e.g., processor capabilities, memory capabilities, etc.) of the edge nodes 712 and/or corresponding resources of the edge nodes 712.

The example communication interface 906 is implemented to facilitate and/or provide communication between the orchestrators 802 of the edge nodes 712. As a result, the orchestrator 802 are able to effectively transfer workloads therebetween. The communication interface 906 can be implemented as hardware and/or software and enables the orchestrators 802 to communicate availability, telemetry data and conditions, orchestrator settings, etc. to one another. In some examples, the communication interface 906 is used to expose an entry point of and/or receive a pod.

The orchestrator controller 908 of the illustrated example determines which of the edge nodes 712 and/or compute resources of the edge nodes 712 are to be assigned at least one workload (e.g., a pod, at least one microservice of an application, etc.) based on the availability determined by the orchestrator analyzer 904, performance requirements of the workload and capabilities of ones of the edge nodes 712 and/or their associated edge clusters 714. In other words, the orchestrator controller 908 makes a scheduling decision to allocate the workload between ones of the edge nodes 712. The orchestrator controller 908 can utilize telemetry data to determine which of the edge nodes 712 are assigned a workload, which can include microservices of an application. In some such examples, the orchestrator controller 908 collects and/or receives the telemetry data via the communication interface 906. Additionally or alternatively, the orchestrator controller 908 assigns the workload to at least one of the edge nodes 712 and/or the edge clusters 714 of the edge nodes 712 based on application fingerprinting in which applications and/or their associated microservices are characterized based on their associated telemetry data (e.g., memory requirements, bandwidth requirements, processing requirements, etc.). Accordingly, the application fingerprinting can be used to assign the workload to at least one of the edge nodes 712. In other words, the workload assignment can be at least partially based on the application fingerprinting. In some examples, a hierarchical topology of the edge nodes 712 is taken into account in assigning the workload. Additionally or alternatively, a best available processing resource, I/O intensive traffic likelihood, storage requirements, etc. are taken into account. In some examples, assigning the workload includes changing a setting (e.g., a QoS setting) of an assigned compute and/or the assigned edge nodes 712.

In some examples, the incentive controller 910 is implemented to forward incentives and/or incentive information to resources of the edge nodes 712, the orchestrator 802 and/or the edge nodes 712. The incentives can be financial, increased flexibility for downtime, etc. As a result, incentives can impact availability of the edge nodes 712 and/or result in an increase of likelihood that at least one of the edge nodes 712 will indicate availability and/or offer available resources. For example, the incentives can be based on interparty agreements and/or the SLA. As a result, the incentives can impact the workload assignments. The incentives can be related to financial incentives for an operator and/or a network manager.

In the illustrated example, the execution monitor 912 monitors execution of applications and/or microservices at the edge nodes 712 and/or the associated edge clusters 714. In this example, the execution monitor 912 monitors execution of an application, an associated microservice and/or a pod of the application and determines whether there is a significant decrease in availability and/or performance. In some particular examples, the execution monitor 912 determines whether the application is experiencing bottlenecks or detects an indication of a bottleneck. If the application is experiencing bottlenecks, the orchestrator controller 908 can be directed to find availability in other resources besides the edge node 712 and/or compute resource experiencing the bottlenecks. Additionally or alternatively, the orchestrator controller 908 can query services and/or the edge nodes 712 along a hierarchical arrangement or topology to find available resources. In some examples, the execution monitor 912 monitors a pod with respect to an application key performance indicator (KPI).

In some examples, the telemetry analyzer 914 is implemented to analyze, compile, access, query and/or store telemetry data associated with the edge nodes 712. For example, the telemetry analyzer 914 can collect data from microservices executed on at least one of the edge nodes 712. Additionally or alternatively, the telemetry analyzer 914 determines telemetry information of the edge nodes 712. The telemetry information can be categorized and/or organized into different categories including, but not limited to, processor utilization, memory usage, cache usage, network latency, network jitter, data access rates, etc.

In some examples, the application analyzer 916 is implemented to analyze applications and associated microservices. For example, at least one performance requirement of an application can be categorized based on its expected resource usage (e.g., network bandwidth usage, processor usage, memory usage, cache usage, etc.). In particular, application fingerprinting can be utilized to characterize the application and/or microservices associated with the application. In some such examples, application fingerprint data can be stored in a knowledge database. Accordingly, the knowledge database can be used by the orchestrators 802 and/or the orchestrator controller 908 to assign workloads to resources of the edge nodes 712 and/or the associated edge cluster 714.

While an example manner of implementing the orchestrator coordinator 900 of FIG. 9 is illustrated in FIG. 9, one or more of the elements, processes and/or devices illustrated in FIG. 9 may be combined, divided, re-arranged, omitted, eliminated and/or implemented in any other way. Further, the example orchestrator analyzer 904, the example communication interface 906, the example orchestrator controller 908, the example incentive coordinator 910, the example execution monitor 912, the example telemetry analyzer 914, the example application analyzer 916 and/or, more generally, the example orchestrator coordinator 900 of FIG. 9 may be implemented by hardware, software, firmware and/or any combination of hardware, software and/or firmware. Thus, for example, any of the example orchestrator analyzer 904, the example communication interface 906, the example orchestrator controller 908, the example incentive controller 910, the example execution monitor 912, the example telemetry analyzer 914, the example application analyzer 916 and/or, more generally, the example orchestrator coordinator 900 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, orchestrator analyzer 904, the example communication interface 906, the example orchestrator controller 908, the example incentive controller 910, the example execution monitor 912, the example telemetry analyzer 914, and/or the example application analyzer 916 is/are hereby expressly defined to include a non-transitory computer readable storage device or storage disk such as a memory, a digital versatile disk (DVD), a compact disk (CD), a Blu-ray disk, etc. including the software and/or firmware. Further still, the example orchestrator coordinator 900 of FIG. 9 may include one or more elements, processes and/or devices in addition to, or instead of, those illustrated in FIG. 9, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

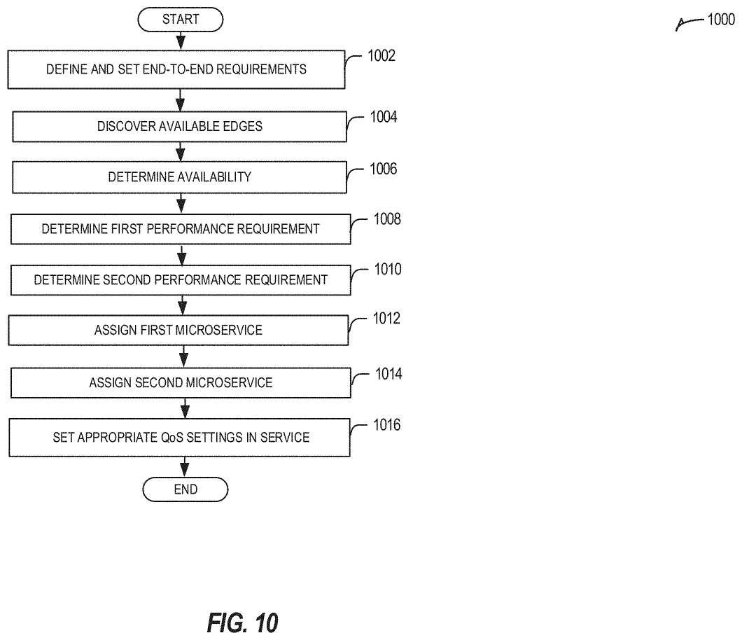

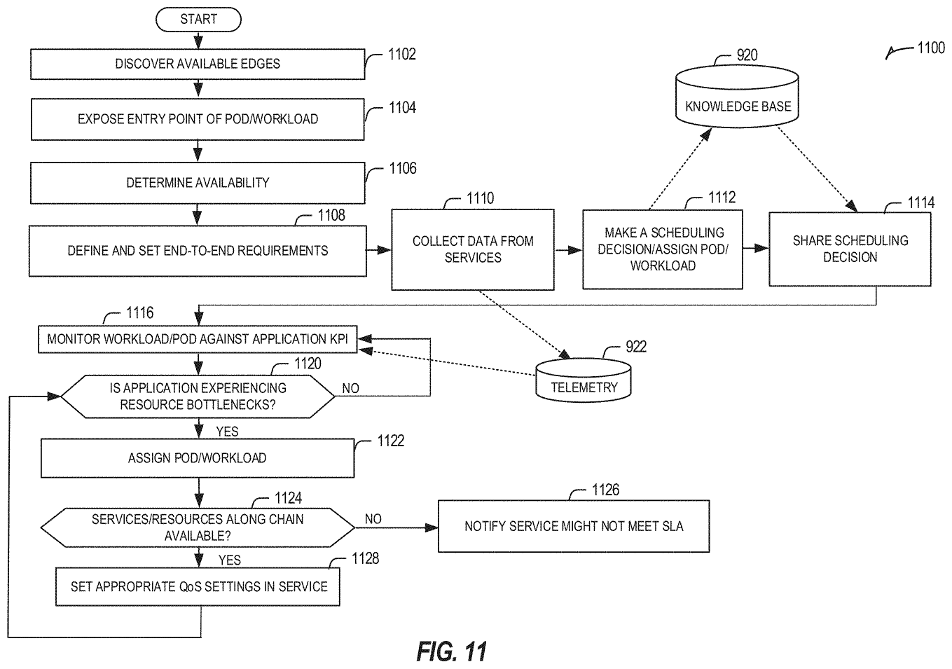

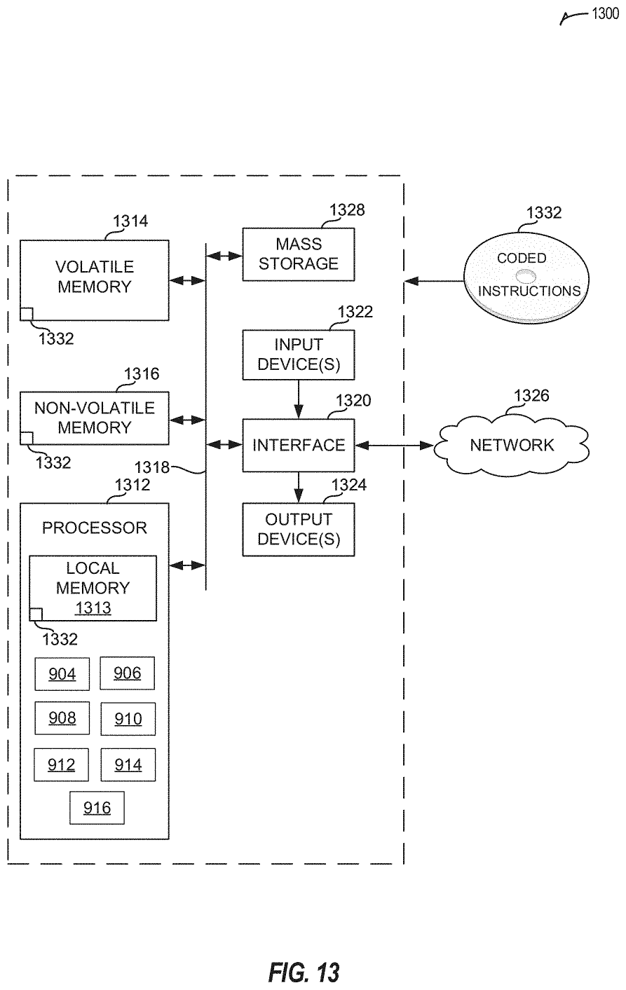

Flowcharts representative of example hardware logic, machine readable instructions, hardware implemented state machines, and/or any combination thereof for implementing the orchestrator coordinator 900 of FIG. 9 are shown in FIGS. 10 and 11. The machine readable instructions may be one or more executable programs or portion(s) of an executable program for execution by a computer processor and/or processor circuitry, such as the processor 1312 shown in the example processor platform 1300 discussed below in connection with FIG. 13. The program may be embodied in software stored on a non-transitory computer readable storage medium such as a CD-ROM, a floppy disk, a hard drive, a DVD, a Blu-ray disk, a solid state drive (SSD) or a memory associated with the processor 1312, but the entire program and/or parts thereof could alternatively be executed by a device other than the processor 1312 and/or embodied in firmware or dedicated hardware. Further, although the example program is described with reference to the flowchart illustrated in FIGS. 10 and 11, many other methods of implementing the example apparatus 50 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example process of FIG. 10 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 10 is a flowchart representative of an example method 1000 to implement the example edge computing system implementations illustrated in connection with FIGS. 1-4, 6-8 and/or 9. In this example, an application with associated microservices is to be allocated and executed on the edge nodes 712. That is, the instructions of FIG. 10 assign microservices of an application for execution by different ones of the edge nodes 712 to implement the application in a distributed manner across those ones of the edge nodes 712. Further, the edge nodes 712 and/or their associated edge clusters 714 have different performance capabilities. In other words, in this example, different ones of the edge nodes 712 are better at different tasks from the other ones of the edge nodes 712. As such, microservices can be assigned to different ones of the edge nodes 712 based on capabilities of the edge nodes 712 satisfying requirements of the microservices.

At block 1002, the example orchestrator analyzer 904 and/or the telemetry analyzer 914 set end-to-end SLA requirements. For example, the SLA can be redefined, modified and/or adjusted. In some such examples, the SLA requirements may be set by an operator, an administrator and/or a developer. In some examples, the SLA requirements are adjusted based on different conditions (e.g., high-traffic network conditions, SLA requirements that are varied over different times, etc.).

At block 1004, the orchestrator analyzer 904 and/or at least one example orchestrator 802 discovers available edges and/or edge resources (e.g., available or unused edge computing resources). In particular, the orchestrator analyzer 904 may determine how many edges are available along a chain and which edges have resource availability. In such examples, capabilities (e.g., memory capability, processor capability, etc.) of the edge nodes 712 are determined by the orchestrator analyzer 904 and/or at least one orchestrator 802. In some examples, edge topology is also determined and/or analyzed. For example, the orchestrator analyzer 904 can determine and/or identify a topological arrangement and/or overall network layout of the edge nodes 712.

At block 1006, the example orchestrator analyzer 904 determines an availability of resources (e.g., compute) of the edge nodes 712. For example, a single orchestrator of a corresponding edge cluster determines an availability of resources of the corresponding edge cluster. In some examples, the orchestrator analyzer 904 causes the pods to load and/or initiate “Good Samaritan” capability data of the resources. In some examples, the “Good Samaritan” capability pertains to when one of the edge nodes 712 indicates or increases an availability of a resource to perform services (e.g., cache services, processing, memory services, storage services, etc.) when another of the edge nodes 712 along the chain indicates potential performance degradation and/or an inability to meet the SLA. In some examples, the edge nodes 712 enacting this capability can release less critical resources to undertake an additional workload from the other edge nodes 712. In some examples, the capability is loaded as a shared library to be accessed by the pods (e.g., K8s pods), the orchestrators 802 and/or the edge nodes 712. Additionally or alternatively, the orchestrators 802 determine telemetry data and/or availability of their respective edge nodes 712 and/or edge clusters 714.

At block 1008, the example orchestrator analyzer 904 determines a first performance requirement of a first microservice of the application. This determination may occur based on application fingerprinting or data queried from the application and/or the first microservice.

At block 1010, the example orchestrator analyzer 904 determines a second performance requirement of a second microservice of the application. For example, the second performance requirement is different from the first performance requirement (e.g., the second performance requirement pertains to a cache memory requirement while the first performance requirement pertains to processor requirements, etc.).

At block 1012, the example orchestrator controller 908 of the illustrated example assigns the first microservice to a first one of the edge nodes 712 based on a first capability (e.g., a performance capability) of the first one of the edge nodes 712 satisfying the first performance requirement of the first microservice.

At block 1014, the example orchestrator controller 908 of the illustrated example assigns the second microservice to a second one of the edge nodes 712 based on a capability (e.g., a performance capability) of the second one of the edge nodes 712 satisfying the second performance requirement of the second microservice. For example, the first performance requirement is related to processor performance, which the first one of the edge nodes 712 is better suited to than the second one of the edge nodes 712. As a further example, the second performance requirement is related to storage capabilities, which the second one of the edges node 712 is better suited than the first one of the edge nodes 712.

At block 1016, in some examples, the example orchestrator controller 908 sets a QoS setting of at least one of the first or second edge nodes 712, and the process ends. The QoS setting can be based on the first and second performance requirements and/or the SLA.

FIG. 11 is a flowchart representative of an example instructions 1100 that may be executed to implement the example edge computing system implementations illustrated in connection with FIGS. 1-4, 6-8 and/or 9. In the illustrated example, workloads (e.g., pods, applications, microservices, FaaS, etc.) between the edge nodes 712, which are arranged in a chain configuration and/or topology between a source network and a destination network, are being coordinated, directed and/or scheduled to ensure that requirements of an end-to-end SLA are being met or exceeded as the access network 706 is utilizing resources of at least one of the edge nodes 712.

At block 1102, the example orchestrator analyzer 904 and/or at least one example orchestrator 802 discovers available edges and/or edge resources (e.g., available or unused edge computing resources). In particular, the example orchestrator analyzer 904 may determine how many edges are available along a chain and which edges have resource availability. In some examples, edge topology is also determined and/or analyzed. For example, the orchestrator analyzer 904 can determine and/or identify a topological arrangement and/or overall network layout of the edge nodes 712.

At block 1104, the example orchestrator analyzer 904 exposes an entry point of a pod/workload (e.g., a K8s pod, a unit of scheduling a compute, a pod, a microservice, a collection of microservices, etc.). In some examples, the entry points are queried by the orchestrator analyzer 904 to report and/or ascertain performance requirement information (e.g., telemetry information) of the pod/workload. As mentioned above, the pod/workload can be a self-executing application and/or application portion that is stored in a container for subsequent execution. According to the illustrated example, the orchestrator analyzer 904 determines and/or identifies which of the edge nodes 712 are to be assigned and/or receive the pod/workload. Additionally or alternatively, the orchestrator analyzer 904 determines and/or analyzes information about the application, application requirements and/or telemetry data associated with the application. For example, the orchestrator analyzer 904 can determine performance requirements of microservices of the application.

At block 1106, the example orchestrator analyzer 904 determines an availability and/or capability (e.g., performance capability) of resources (e.g., compute) of the edge nodes 712. For example, a single orchestrator of a corresponding edge cluster determines an availability of resources and capability of the corresponding edge cluster(s). In some examples, the orchestrator analyzer 904 causes the pods to load and/or initiate “Good Samaritan” capability data of the resources. In some examples, the “Good Samaritan” capability pertains to when one of the edge nodes 712 indicates or increases an availability of a resource to perform services (e.g., cache services, processing, memory services, storage services, etc.) when another of the edge nodes 712 along the chain indicates potential performance degradation and/or an inability to meet the SLA. In some examples, the edge nodes 712 enacting this capability can release less critical resources to undertake an additional workload from the other edge nodes 712. In some examples, the capability is loaded as a shared library to be accessed by the pods (e.g., K8s pods), the orchestrators 802 and/or the edge nodes 712. In particular, the shared library can indicate which of the edge nodes 712 are available for utilization. Additionally or alternatively, the orchestrators 802 determine telemetry data and/or availability of their respective edge nodes 712 and/or edge clusters 714.

At block 1108, in some examples, the example orchestrator analyzer 904 and/or the telemetry analyzer 914 defines end-to-end SLA requirements. For example, the SLA can be redefined, modified and/or adjusted. In some such examples, the SLA requirements may be set by an operator, an administrator and/or a developer. In some examples, the SLA requirements are adjusted based on different conditions (e.g., high-traffic network conditions, SLA requirements that are varied over different times, etc.).

At block 1110, the example orchestrator analyzer 904 and/or the telemetry analyzer 914 collects data from services of the edge nodes 712 and/or the associated edge clusters 714. The data can include information related to telemetry, application telemetry, resource availability and/or telemetry data, etc. and can be stored in the telemetry data storage 922.

At block 1112, the orchestrator controller 908 makes a scheduling decision based on the availability, performance requirements of the pod/workload and capabilities of the resources for compliance with the SLA. In other words, the orchestrator assigns the pod/workload, which can include multiple microservices, to at least one resource (e.g., a compute resource) of the edge nodes 712 and/or the respective edge clusters 714 based on the availability and requirements of the SLA. Additionally or alternatively, the orchestrator controller 908 makes the schedule based on application fingerprinting (e.g., application telemetry data, application usage data, etc.), which characterizes applications for processor usage, memory usage, etc. In some examples, the aforementioned scheduling decision, application information and/or associated application telemetry data is stored in the knowledge base 920. Additionally or alternatively, the orchestrator controller 908 utilizes a cost function in which a scheduling decision of deploying workload and/or applications to ones of the edge nodes 712 is performed based on selecting resources and/or ones of the edge nodes 712 that result in a lowest calculated cost (e.g., energy costs, computational costs, latency costs, resource costs, etc.). In some examples, a tenancy is taken into account. In particular, crossing tenant isolation boundaries can sometimes incur performance penalties, for example. In some examples, the scheduling decision is made to meet the requirements set forth by the SLA (e.g., the scheduling decision is made so that the requirements of the SLA are met or only slightly exceeded). Additionally or alternatively, the scheduling decision is made to exceed and/or maximize overall performance of the edge nodes 712. In some examples, assigning the pod/workload includes changing a setting (e.g., a QoS setting) of the assigned compute. Additionally or alternatively, the scheduling decision is based on an objective of fast computation by selecting a resource with a better performing processor, selecting resources to better accommodate I/O intensive traffic (e.g., use of a high throughput I/O node) or a resource with relatively larger storage capabilities.

At block 1114, in some examples, the orchestrator controller 908 provides, transmits and/or shares the scheduling decision with the edge nodes 712 and/or the edge clusters 714 (e.g., nearby, adjacent or proximate ones of the edge nodes 712 and/or the edge clusters). In some examples, only the edge clusters 714 of the corresponding edge node 712 are provided with the scheduling decision. In some examples, transmitting the shared scheduling decision causes the assigned edge node 712 and/or its corresponding orchestrator 802 to receive and/or retrieve the pod/workload assigned thereto.

At block 1116, the example execution monitor 912 monitors the pod/workload. For example, the execution monitor 912 monitors execution of the pod/workload against an application KPI. In some examples, telemetry data is used in monitoring the pod/workload.

At block 1120, the example application analyzer 916 and/or the example execution monitor 912 determines whether the application is experiencing diminished performance (e.g., bottlenecks). For example, execution of the microservices can be monitored so that at least one of the microservices can be redistributed and/or reassigned to another one of the edge nodes 712. If the application is experiencing diminished performance (block 1120), control returns to block 1116. Otherwise, the instructions proceed to block 1122.

At block 1122, in some examples, the orchestrator controller 908 assigns the pod/workload to an available one of the edge nodes 712 and/or the associated orchestrator 802. For example, the aforementioned “Good Samaritan” capability is use. For example, the “Good Samaritan” capability can be executed with a shared library that is enabled and parameterized by each application so that when a pod/workload is contacted by the orchestrator controller 908 and/or the orchestrator 802, resources (e.g., resources that are less critical) may be released and/or assigned to an appropriate degree and/or proportion. In other words, the orchestrator 802 can indicate what resources of the edge nodes 712 are available and/or which compute resources are in a relatively idle state. Additionally or alternatively, the pod/workload can be shifted to proxies in a cloud to mitigate resource bottlenecks. The reassignment and/or redistribution of the microservices to available resources can be related to monitoring associated with block 1120. The redistribution of the pod/workload can be based on platform telemetry including cache misses, network jitter, dropped packets, latency, memory usage, bandwidth, latency excursion, storage latency and/or read latency, etc.

At block 1124, in some examples, the orchestrator analyzer 904 determines whether resources/resources of the edge nodes 712 and/or the edge clusters 714 are available (e.g., to meet the SLA) and/or have available resources. If the resources are available (block 1124), control of the process proceeds to block 1126. Otherwise, the instructions proceed to block 1128.

At block 1126, in some examples, the orchestrator analyzer 904 sends a notification indicating that the SLA may not be met. The notification can be sent to an administrator or a central office/server.

At block 1128, the example orchestrator controller 908 of the illustrated example sets appropriate QoS and/or SLA settings in a resource that is available and the instructions return to block 1120.

FIG. 12A is a block diagram of an example implementation of an example edge compute node (e.g., a compute) 1200 that includes a compute engine (also referred to herein as “compute circuitry”) 1202, an input/output (I/O) subsystem 1208, data storage 1210, a communication circuitry subsystem 1212, and, optionally, one or more peripheral devices 1214. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component. The example edge compute node 1200 of FIG. 12 may be deployed in one of the edge computing systems illustrated in FIGS. 1-4, 6-8 and/or 9 to implement any edge compute node shown in examples disclosed herein.

The compute node 1200 may be embodied as any type of engine, device, or collection of devices capable of performing various compute functions. In some examples, the compute node 1200 may be embodied as a single device such as an integrated circuit, an embedded system, a field-programmable gate array (FPGA), a system-on-a-chip (SOC), or other integrated system or device. In the illustrative example, the compute node 1200 includes or is embodied as a processor 1204 and a memory 1206. The processor 1204 may be embodied as any type of processor capable of performing the functions described herein (e.g., executing an application). For example, the processor 1204 may be embodied as a multi-core processor(s), a microcontroller, a processing unit, a specialized or special purpose processing unit, or other processor or processing/controlling circuit.

In some examples, the processor 1204 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 1204 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry data), outside of the CPU or general purpose processing hardware. However, it will be understood that a xPU, a SOC, a CPU, and other variations of the processor 1204 may work in coordination with each other to execute many types of operations and instructions within and on behalf of the compute node 1200.

The memory 1206 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 1206 may be integrated into the processor 1204. The memory 1206 may store various software and data used during operation such as one or more applications, data operated on by the application(s), libraries, and drivers.

The compute circuitry 1202 is communicatively coupled to other components of the compute node 1200 via the I/O subsystem 1208, which may be embodied as circuitry and/or components to facilitate input/output operations with the compute circuitry 1202 (e.g., with the processor 1204 and/or the main memory 1206) and other components of the compute circuitry 1202. For example, the I/O subsystem 1208 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1208 may form a portion of a system-on-a-chip (SoC) and be incorporated, along with one or more of the processor 1204, the memory 1206, and other components of the compute circuitry 1202, into the compute circuitry 1202.

The one or more illustrative data storage devices 1210 may be embodied as any type of devices configured for short-term or long-term storage of data such as, for example, memory devices and circuits, memory cards, hard disk drives, solid-state drives, or other data storage devices. Individual data storage devices 1210 may include a system partition that stores data and firmware code for the data storage device 1210. Individual data storage devices 1210 may also include one or more operating system partitions that store data files and executables for operating systems depending on, for example, the type of compute node 1200.

The communication circuitry 1212 may be embodied as any communication circuit, device, or collection thereof, capable of enabling communications over a network between the compute circuitry 1202 and another compute device (e.g., an edge gateway of an implementing edge computing system). The communication circuitry 1212 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 1212 includes a network interface controller (NIC) 1220, which may also be referred to as a host fabric interface (HFI). The NIC 1220 may be embodied as one or more add-in-boards, daughter cards, network interface cards, controller chips, chipsets, or other devices that may be used by the compute node 1200 to connect with another compute device (e.g., an edge gateway node). In some examples, the NIC 1220 may be embodied as part of a system-on-a-chip (SoC) that includes one or more processors, or included on a multichip package that also contains one or more processors. In some examples, the NIC 1220 may include a local processor (not shown) and/or a local memory (not shown) that are both local to the NIC 1220. In such examples, the local processor of the NIC 1220 may be capable of performing one or more of the functions of the compute circuitry 1202 described herein. Additionally, or alternatively, in such examples, the local memory of the NIC 1220 may be integrated into one or more components of the client compute node at the board level, socket level, chip level, and/or other levels.

Additionally, in some examples, a respective compute node 1200 may include one or more peripheral devices 1214. Such peripheral devices 1214 may include any type of peripheral device found in a compute device or server such as audio input devices, a display, other input/output devices, interface devices, and/or other peripheral devices, depending on the particular type of the compute node 1200. In further examples, the compute node 1200 may be embodied by a respective edge compute node (whether a client, gateway, or aggregation node) in an edge computing system or like forms of appliances, computers, subsystems, circuitry, or other components.

In a more detailed example, FIG. 12B illustrates a block diagram of an example may edge computing node 1250 structured to implement the techniques (e.g., operations, processes, methods, and methodologies) described herein. This edge computing node 1250 provides a closer view of the respective components of node 1200 when implemented as or as part of a computing device (e.g., as a mobile device, a base station, server, gateway, etc.). The edge computing node 1250 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 1250, or as components otherwise incorporated within a chassis of a larger system. For example, the edge computing node 1250 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, an Internet of Things (IoT) device, or any other type of computing device.

The edge computing device 1250 may include processing circuitry in the form of a processor 1252, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 1252 may be a part of a system on a chip (SoC) in which the processor 1252 and other components are formed into a single integrated circuit, or a single package, such as the Edison™ or Galileo™ SoC boards from Intel Corporation, Santa Clara, Calif. As an example, the processor 1252 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 1252 and accompanying circuitry may be provided in a single socket form factor, multiple socket form factor, or a variety of other formats, including in limited hardware configurations or configurations that include fewer than all elements shown in FIG. 12B.

The processor 1252 may communicate with a system memory 1254 over an interconnect 1256 (e.g., a bus). Any number of memory devices may be used to provide for a given amount of system memory. As examples, the memory 1254 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDlMMs or MiniDIMMs.

To provide for persistent storage of information such as data, applications, operating systems and so forth, a storage 1258 may also couple to the processor 1252 via the interconnect 1256. In an example, the storage 1258 may be implemented via a solid-state disk drive (SSDD). Other devices that may be used for the storage 1258 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1258 may be on-die memory or registers associated with the processor 1252. However, in some examples, the storage 1258 may be implemented using a micro hard disk drive (HDD). Further, any number of new technologies may be used for the storage 1258 in addition to, or instead of, the technologies described, such resistance change memories, phase change memories, holographic memories, or chemical memories, among others.

The components may communicate over the interconnect 1256. The interconnect 1256 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1256 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 1256 may couple the processor 1252 to a transceiver 1266, for communications with the connected edge devices 1262. The transceiver 1266 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1262. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1266 (or multiple transceivers) may communicate using multiple standards or radios for communications at a different range. For example, the edge computing node 1250 may communicate with close devices, e.g., within about 10 meters, using a local transceiver based on Bluetooth Low Energy (BLE), or another low power radio, to save power. More distant connected edge devices 1262, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 1266 (e.g., a radio transceiver) may be included to communicate with devices or services in the edge cloud 1290 via local or wide area network protocols. The wireless network transceiver 1266 may be a low-power wide-area (LPWA) transceiver that follows the IEEE 802.15.4, or IEEE 802.15.4g standards, among others. The edge computing node 1250 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1266, as described herein. For example, the transceiver 1266 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1266 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1268 may be included to provide a wired communication to nodes of the edge cloud 1290 or to other devices, such as the connected edge devices 1262 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1268 may be included to enable connecting to a second network, for example, a first NIC 1268 providing communications to the cloud over Ethernet, and a second NIC 1268 providing communications to other devices over another type of network.

Given the variety of types of applicable communications from the device to another component or network, applicable communications circuitry used by the device may include or be embodied by any one or more of components 1264, 1266, 1268, or 1270. Accordingly, in various examples, applicable means for communicating (e.g., receiving, transmitting, etc.) may be embodied by such communications circuitry.

The edge computing node 1250 may include or be coupled to acceleration circuitry 1264, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 1256 may couple the processor 1252 to a sensor hub or external interface 1270 that is used to connect additional devices or subsystems. The devices may include sensors 1272, such as accelerometers, level sensors, flow sensors, optical light sensors, camera sensors, temperature sensors, global navigation system (e.g., GPS) sensors, pressure sensors, barometric pressure sensors, and the like. The hub or interface 1270 further may be used to connect the edge computing node 1250 to actuators 1274, such as power switches, valve actuators, an audible sound generator, a visual warning device, and the like.

In some optional examples, various input/output (I/O) devices may be present within or connected to, the edge computing node 1250. For example, a display or other output device 1284 may be included to show information, such as sensor readings or actuator position. An input device 1286, such as a touch screen or keypad may be included to accept input. An output device 1284 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 1250. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1276 may power the edge computing node 1250, although, in examples in which the edge computing node 1250 is mounted in a fixed location, it may have a power supply coupled to an electrical grid, or the battery may be used as a backup or for temporary capabilities. The battery 1276 may be a lithium ion battery, or a metal-air battery, such as a zinc-air battery, an aluminum-air battery, a lithium-air battery, and the like.

A battery monitor/charger 1278 may be included in the edge computing node 1250 to track the state of charge (SoCh) of the battery 1276, if included. The battery monitor/charger 1278 may be used to monitor other parameters of the battery 1276 to provide failure predictions, such as the state of health (SoH) and the state of function (SoF) of the battery 1276. The battery monitor/charger 1278 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1278 may communicate the information on the battery 1276 to the processor 1252 over the interconnect 1256. The battery monitor/charger 1278 may also include an analog-to-digital (ADC) converter that enables the processor 1252 to directly monitor the voltage of the battery 1276 or the current flow from the battery 1276. The battery parameters may be used to determine actions that the edge computing node 1250 may perform, such as transmission frequency, mesh network operation, sensing frequency, and the like.

A power block 1280, or other power supply coupled to a grid, may be coupled with the battery monitor/charger 1278 to charge the battery 1276. In some examples, the power block 1280 may be replaced with a wireless power receiver to obtain the power wirelessly, for example, through a loop antenna in the edge computing node 1250. A wireless battery charging circuit, such as an LTC4020 chip from Linear Technologies of Milpitas, Calif., among others, may be included in the battery monitor/charger 1278. The specific charging circuits may be selected based on the size of the battery 1276, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1258 may include instructions 1282 in the form of software, firmware, or hardware commands to implement the techniques described herein. Although such instructions 1282 are shown as code blocks included in the memory 1254 and the storage 1258, it may be understood that any of the code blocks may be replaced with hardwired circuits, for example, built into an application specific integrated circuit (ASIC).

In an example, the instructions 1282 provided via the memory 1254, the storage 1258, or the processor 1252 may be embodied as a non-transitory, machine-readable medium 1260 including code to direct the processor 1252 to perform electronic operations in the edge computing node 1250. The processor 1252 may access the non-transitory, machine-readable medium 1260 over the interconnect 1256. For instance, the non-transitory, machine-readable medium 1260 may be embodied by devices described for the storage 1258 or may include specific storage units such as optical disks, flash drives, or any number of other hardware devices. The non-transitory, machine-readable medium 1260 may include instructions to direct the processor 1252 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 1282 on the processor 1252 (separately, or in combination with the instructions 1282 of the machine readable medium 1260) may configure execution or operation of a trusted execution environment (TEE) 1290. In an example, the TEE 1290 operates as a protected area accessible to the processor 1252 for secure execution of instructions and secure access to data. Various implementations of the TEE 1290, and an accompanying secure area in the processor 1252 or the memory 1254 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1250 through the TEE 1290 and the processor 1252.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

FIG. 13 is a block diagram of an example processor platform 1300 structured to execute the instructions of FIGS. 10 and 11 to implement the orchestrator coordinator 900 of FIG. 9. The processor platform 1300 can be, for example, a server, a personal computer, a workstation, a self-learning machine (e.g., a neural network), or any other type of computing device.

The processor platform 1300 of the illustrated example includes a processor 1312. The processor 1312 of the illustrated example is hardware. For example, the processor 1312 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example orchestrator analyzer 904, the example communication interface 906, the example orchestration manager 908, the example incentive controller 910, the example execution monitor 912, the example telemetry analyzer 914 and the example application analyzer 916.

The processor 1312 of the illustrated example includes a local memory 1313 (e.g., a cache). The processor 1312 of the illustrated example is in communication with a main memory including a volatile memory 1314 and a non-volatile memory 1316 via a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1316 may be implemented by flash memory and/or any other desired type of memory device. Access to the main memory 1314, 1316 is controlled by a memory controller.

The processor platform 1300 of the illustrated example also includes an interface circuit 1320. The interface circuit 1320 may be implemented by any type of interface standard, such as an Ethernet interface, a universal serial bus (USB), a Bluetooth® interface, a near field communication (NFC) interface, and/or a PCI express interface.

In the illustrated example, one or more input devices 1322 are connected to the interface circuit 1320. The input device(s) 1322 permit(s) a user to enter data and/or commands into the processor 1312. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1324 are also connected to the interface circuit 1320 of the illustrated example. The output devices 1324 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1320 of the illustrated example, thus, typically includes a graphics driver card, a graphics driver chip and/or a graphics driver processor.

The interface circuit 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1326. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1300 of the illustrated example also includes one or more mass storage devices 1328 for storing software and/or data. Examples of such mass storage devices 1328 include floppy disk drives, hard drive disks, compact disk drives, Blu-ray disk drives, redundant array of independent disks (RAID) systems, and digital versatile disk (DVD) drives.

Example machine executable instructions 1332 of FIGS. 10 and 11 may be stored in the mass storage device 1328, in the volatile memory 1314, in the non-volatile memory 1316, and/or on a removable non-transitory computer readable storage medium such as a CD or DVD.

From the foregoing, it will be appreciated that example methods, apparatus and articles of manufacture have been disclosed that enable a system of edges to effectively coordinate workloads therebetween to better meet requirements set forth by an SLA (e.g., an end-to-end SLA). The disclosed methods, apparatus and articles of manufacture improve the efficiency of using a computing device by more efficiently processing workloads and, in some cases, reducing overall computing and/or processing times. The disclosed methods, apparatus and articles of manufacture are accordingly directed to one or more improvement(s) in the functioning of a computer.

Example 1 includes an apparatus to control processing of data associated with edges. The apparatus includes an orchestrator analyzer to determine a first performance requirement of a first microservice of an application and a second performance requirement of a second microservice of the application. The apparatus also includes an orchestrator controller to assign the first microservice and the second microservice across first and second edge nodes between a source network and a destination network by: assigning the first microservice to the first edge node based on a first capability of the first edge node satisfying the first performance requirement of the first microservice, and assigning the second microservice to the second edge node based on a second capability of the second edge node satisfying the second performance requirement of the second microservice.

Example 2 includes the apparatus as defined in example 1, wherein at least one of the first or second microservices is assigned based on the at least one of the first or second edge nodes transmitting information regarding availability thereof.

Example 3 includes the apparatus as defined in any of examples 1 or 2, wherein a pod of the application is to receive the information regarding the availability.

Example 4 includes the apparatus as defined in any of examples 1 to 3, wherein the orchestrator controller is to define a quality of service (QoS) setting associated with the assigned edge node.

Example 5 includes the apparatus as defined in any of examples 1 to 4, further including an application analyzer to query the application and determine the first performance requirement and the second performance requirement.

Example 6 includes the apparatus as defined in example 5, wherein the application analyzer is to determine an application fingerprint corresponding to the application.

Example 7 includes the apparatus as defined in any of examples 1 to 6, further including an incentive controller to provide an incentive to at least one of the first or second edge nodes based on at least one of the first performance requirement or the second performance requirement.

Example 8 includes the apparatus as defined in any of examples 1 to 7, further including an execution monitor to monitor execution of the first microservice and the second microservice, an indication of a bottleneck during the execution to cause the orchestrator controller to transfer at least one of the first microservice or the second microservice to another edge node.

Example 9 includes the apparatus as defined in any of examples 1 to 8, wherein the first microservice and the second microservice are assigned to respective ones of the first edge node and the second edge node to meet an SLA (service level agreement).

Example 10 includes the apparatus as defined in any of examples 1 to 9, wherein at least one orchestrator of the first edge node or the second edge node includes the orchestrator controller.

Example 11 includes a method of allocating first and second microservices of an application across first and second edge nodes between a source network and a destination network. The method is to be performed by at least one processor executing at least one instruction to: determine a first performance requirement of the first microservice, and determine the second performance requirement of the second microservice. The at least one processor is to further assign an instruction with the at least one processor, the first microservice to the first edge node based on a first capability of the first edge node satisfying the first performance requirement of the first microservice, and assign the second microservice to the second edge based on a second capability of the second edge node satisfying the second performance requirement of the second microservice.

Example 12 includes the method as defined in example 11, wherein at least one of the first or second microservices is assigned based on the at least one of the first or second edge nodes transmitting information regarding availability thereof.

Example 13 includes the method as defined in example 12, wherein the at least one processor is further caused to forward the information regarding the availability to a pod of the application.

Example 14 includes the method as defined in any of examples 11 to 13, wherein the at least one processor is further caused to define a first quality of service (QoS) setting associated with the first edge node, and define a second QoS setting associated with the second edge node.

Example 15 includes the method as defined in any of examples 11 to 14, wherein the at least one processor is further caused to query the application to determine application telemetry data.

Example 16 includes the method as defined in example 15, wherein the application telemetry data is determined based on application fingerprints.

Example 17 includes the method as defined in any of examples 11 to 16, wherein the at least one processor is further caused to provide an incentive to at least one of the first or second edge nodes based on at least one of the first performance requirement or the second performance requirement.

Example 18 includes the method as defined in any of examples 11 to 17, wherein the at least one processor is further caused to monitor execution of microservices of the application, and in response to an indication of a bottleneck during the execution, transfer at least one of the first microservice or the second microservice to another edge node.

Example 19 includes the method as defined in any of examples 11 to 18, wherein the at least one processor is further caused to forward the assignment of the first edge node and the assignment of the second edge node to at least one orchestrator of the first or second edge nodes.

Example 20 includes a non-transitory machine readable medium comprising instructions which, when executed, cause a processor to at least: determine a first performance requirement of a first microservice of an application, determine a second performance requirement of a second microservice of the application, assign the first microservice to a first edge node between a source network and a destination network based on a first capability of the first edge node satisfying the first performance requirement of the first microservice, and assign the second microservice to a second edge node between the source and destination networks based on a second capability of the second edge node satisfying the second performance requirement of the second microservice.

Example 21 includes the non-transitory machine readable medium as defined in example 20, wherein at least one of the first or second microservices is assigned based on the at least one of the first or second edge nodes transmitting information regarding availability thereof.

Example 22 includes the non-transitory machine readable medium as defined in example 21, wherein the instructions are to further cause the at least one processor to forward the information regarding the availability to a pod of the application.

Example 23 includes the non-transitory machine readable medium as defined in any of examples 20 to 22, wherein the processor is further caused to set a first quality of service (QoS) setting associated with the first edge node, and set a second QoS setting associated with the second edge node.

Example 24 includes the non-transitory machine readable medium as defined in any of examples 20 to 23, wherein the instructions are to further cause the at least one processor to query the application to determine application telemetry data.

Example 25 includes the non-transitory machine readable medium as defined in example 24, wherein the instructions are to further cause the at least one processor to determine the application telemetry data based on application fingerprints.

Example 26 includes the non-transitory machine readable medium as defined in any of examples 20 to 25, wherein the instructions are to further cause the at least one processor to monitor execution of the first microservice and the second microservice, and in response to an indication of a bottleneck during the execution, transfer at least one of the first microservice or the second microservice to another edge node.

Example 27 includes the non-transitory machine readable medium as defined in any of examples 20 to 26, wherein the instructions are to further cause the at least one processor to forward the assignment of the first edge node and the assignment of the second edge node to at least one orchestrator of least one of the first or second edge nodes.

Example 28 includes an apparatus including means for determining first and second performance requirements of first and second microservices, respectively, of an application, and means for assigning the first and second microservices across first and second edge nodes between a source network and a destination network.

Example 29 includes the apparatus as defined in example 28, further including means for transmitting an availability of at least one of the first or second edge nodes.

Example 30 includes the apparatus as defined in any of examples 28 or 29, further including means for providing an incentive to at least one of the first or second edge nodes.

Example 31 includes the apparatus as defined in any of examples 28 to 30, further including means for monitoring execution of the first and second microservices.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An apparatus to control processing of data associated with edges, the apparatus comprising:
an orchestrator analyzer to determine a first performance requirement of a first microservice of an application and a second performance requirement of a second microservice of the application; and
an orchestrator controller to assign the first microservice and the second microservice across first and second edge nodes between a source network and a destination network by:
assigning the first microservice to the first edge node based on a first capability of the first edge node satisfying the first performance requirement of the first microservice, and
assigning the second microservice to the second edge node based on a second capability of the second edge node satisfying the second performance requirement of the second microservice.

2. The apparatus as defined in claim 1, wherein at least one of the first or second microservices is assigned based on the at least one of the first or second edge nodes transmitting information regarding availability thereof

3. The apparatus as defined in claim 2, wherein a pod of the application is to receive the information regarding the availability.

4. The apparatus as defined in claim 1, wherein the orchestrator controller is to define a quality of service (QoS) setting associated with the assigned edge node.

5. The apparatus as defined in claim 1, further including an application analyzer to query the application and determine the first performance requirement and the second performance requirement.

6. The apparatus as defined in claim 5, wherein the application analyzer is to determine an application fingerprint corresponding to the application, wherein the first and second performance requirements are based on the application fingerprint.

7. The apparatus as defined in claim 1, further including an incentive controller to provide an incentive to at least one of the first or second edge nodes based on at least one of the first performance requirement or the second performance requirement.

8. The apparatus as defined in claim 1, further including an execution monitor to monitor execution of the first microservice and the second microservice, an indication of a bottleneck during the execution to cause the orchestrator controller to transfer at least one of the first microservice or the second microservice to another edge node.

9. The apparatus as defined in claim 1, wherein the first microservice and the second microservice are assigned to respective ones of the first edge node and the second edge node to meet an SLA (service level agreement).

10. The apparatus as defined in claim 1, wherein at least one orchestrator of the first edge node or the second edge node includes the orchestrator controller.

11.-19. (canceled)

20. A non-transitory machine readable medium comprising instructions which, when executed, cause at least one processor to at least:
determine a first performance requirement of a first microservice of an application;
determine a second performance requirement of a second microservice of the application;
assign the first microservice to a first edge node between a source network and a destination network based on a first capability of the first edge node satisfying the first performance requirement of the first microservice, and
assign the second microservice to a second edge node between the source and destination networks based on a second capability of the second edge node satisfying the second performance requirement of the second microservice.

21. The non-transitory machine readable medium as defined in claim 20, wherein at least one of the first or second microservices is assigned based on the at least one of the first or second edge nodes transmitting information regarding availability thereof.

22. The non-transitory machine readable medium as defined in claim 21, wherein the instructions are to further cause the at least one processor to forward the information regarding the availability to a pod of the application.

23. The non-transitory machine readable medium as defined in claim 20, wherein the instructions are to further cause the at least one processor to:
set a first quality of service (QoS) setting associated with the first edge node; and
set a second QoS setting associated with the second edge node.

24. The non-transitory machine readable medium as defined in claim 20, wherein the instructions are to further cause the at least one processor to query the application to determine application telemetry data.

25. The non-transitory machine readable medium as defined in claim 24, wherein the instructions are to further cause the at least one processor to determine the application telemetry data based on application fingerprints.

26. The non-transitory machine readable medium as defined in claim 20, wherein the instructions are to further cause the at least one processor to:
monitor execution of the first microservice and the second microservice; and
in response to an indication of a bottleneck during the execution, transfer at least one of the first microservice or the second microservices to another edge node.

27. The non-transitory machine readable medium as defined in claim 20, wherein the instructions are to further cause the at least one processor to forward the assignment of the first edge node and the assignment of the second edge node to at least one orchestrator of least one of the first or second edge nodes.

28. An apparatus comprising:
means for determining first and second performance requirements of first and second microservices, respectively, of an application; and
means for assigning the first and second microservices across first and second edge nodes between a source network and a destination network.

29. The apparatus as defined in claim 28, further including means for transmitting an availability of at least one of the first or second edge nodes.

30. The apparatus as defined in claim 28, further including means for providing an incentive to at least one of the first or second edge nodes.

31. The apparatus as defined in claim 28, further including means for monitoring execution of the first and second microservices.
